(19) United States
(12) Patent Application Publication
(10) Pub. No.: US 2023/0001609 A1
(43) Pub. Date: Jan. 5, 2023

(54) PROCESS FOR PRODUCING A STRUCTURED AND OPTIONALLY COATED ARTICLE AND ARTICLE OBTAINED FROM SAID PROCESS

(71) Applicant: BASF Coatings GmbH, Münster (DE)

(72) Inventors: Karin Reuter, Münster (DE); Tim Buscher, Münster (DE); Simon Winzen, Münster (DE); Martin Wilhelmer, Münster (DE); Sven Olle Krabbenborg, Münster (DE)

(21) Appl. No.: 17/784,847

(22) PCT Filed: Nov. 30, 2020
(86) PCT No.: PCT/EP2020/083935

§ 371 Date: Jun. 13, 2022

(30) Foreign Application Priority Data
Dec. 18, 2019 (EP) 19217321.9

(51) Int. Cl. B29C 44/42; B29C 33/38; B29C 44/56; B29C 44/02; B29C 44/58

(52) U.S. Cl. CPC B29C 44/428; B29C 33/3842; B29C 44/56; B29C 44/02; B29C 44/58; B29K 2075/00

(57) ABSTRACT

Described herein is a process for preparing a molded article including at least one structured surface, said process including applying a composition, preferably a foam material, into a mold having at least one structured inner surface and curing said composition to provide the molded structured article. The inner surfaces of the mold can be coated with a coating composition to obtain molded structured articles further including a flexible and durable coating layer. The present invention also relates to a structured molded article, preferably a shoe sole, which is obtained by the process.

The present invention relates to a process for preparing a molded article comprising at least one structured surface, said process comprising applying a composition, preferably a foam material, into a mold having at least one structured inner surface (SU1) and curing said composition to provide the molded structured article. The inner surfaces of the mold can be coated with a coating composition to obtain molded structured articles further comprising a flexible and durable coating layer. The present invention also relates to a structured molded article, preferably a shoe sole, which is obtained by the inventive process.

### STATE OF THE ART

A wide variety of different components with variable layer thicknesses are nowadays mostly produced by means of molding processes, like injection molding and casting processes. A greatly used material in molding processes are polymer foams. Polymer foams belong to the solid foam family which are versatile materials, extensively used for a large number of applications such as automotive, packaging, sport products, thermal and acoustic insulators, tissue engineering or liquid absorbents. Composed of air bubbles entrapped in a continuous solid network, they combine the properties of the polymer with those of the foam to create an intriguing and complex material. Polymer foams not only allow to use the wide range of interesting properties that the polymers offers, but also permit to profit from the advantageous properties of foams, including lightness, low density, compressibility and high surface-to-volume ratio.

Structural foam molded thermoplastics exhibit a characteristic swirl pattern or a mottled surface that can be attractive on durable outdoor, industrial or factory applications. However, the as-molded structural foam appearance isn't appropriate for all products. Particularly in the area of the production of footwear soles or in the area of the furniture industry, there is a sustained demand for foam components produced by molding process having an attractive appearance. One way of providing such an attractive appearance is by post-treatment of the molded parts, for example by sanding, coating and texturizing. Textured surfaces can be applied for aesthetic purposes or to reduce finger prints when the finished product will receive a lot of handling. A textured finish also assists in hiding blemishes in the surface created during the molding process.

Such processes, however, are inefficient, since they necessitate a further process step after production. Moreover, prior to further coating with a basecoat, for example, or to adhesive bonding to other components, it is necessary to remove the external release agent used when producing the components, and permitting demolding of the components from the molding tool without damage; such removal entails costly and inconvenient cleaning processes. Furthermore, the tools used must also be subjected to ongoing cleaning.

Of advantage accordingly would be a process for preparing structured molded articles preferably made from polymer foam, especially structured shoe soles made by molding processes using polymer foams, wherein the texturization and optionally coating of the polymer foam can be obtained during the molding process, thus rendering post-treatment of said articles superfluous. The texture transfer from the structured mold to the polymer foam should be highly accurate. Additionally, it would be desirable to provide a process where coating of the texturized polymer foam can be performed during the molding process in order to reduce the post-treatment steps of the texturized molded article.

### Object

The object of the present invention, accordingly, was that of providing a process which allows texturization and optionally coating of a molded material, preferably foam material, during the molding process, thus rendering post-texturization and post-coating superfluous. The structure of the inner mold surface(s) should be transferred to the molded material with a high molding accuracy without negatively influencing the removal of the molded article from the mold. Despite the texturization of the material, the coating should have a high adhesion and a sufficient flexibility to allow repeated bending of the molded material without detachment of said coating layer. The process should also allow the production of components of complex geometry without any defects occurring during the molding process.

### Technical Solution

The objects described above are achieved by the subject matter claimed in the claims and also by the preferred embodiments of that subject matter that are described in the description hereinafter.

A first subject of the present invention is therefore a process for preparing a molded article comprising at least one structured surface, said process comprising the following steps in the stated order:
(1) providing a closable, three dimensional mold (MO) having at least two mold parts which are movable relative to each other and which form a mold cavity, wherein at least one micro- and/or nanostructured silicone containing layer comprising a plurality of micro-scale and/or nano-scale surface elements is attached to at least a part of the inner surface (SU) facing the mold cavity of at least one of the mold parts;
(2) optionally applying a composition (C2a) comprising at least one binder (B) and optionally at least one crosslinker (CL) on at least a part of at least one inner surface (SU) facing the mold cavity of the closable, three dimensional mold (MO) and flashing off said applied composition (C2a);
(3) optionally inserting at least one material (M1) into the mold (MO), wherein the at least one material (M1) is preferably not in contact with the inner surface (SU) of the mold parts comprising the silicone containing layer, and heating the mold (MO);
(4) optionally closing the mold (MO);
(5) applying a composition (C3a) into the closed mold (MO) or applying a composition (C3a) into the open mold (MO) and closing said mold (MO);
(6) at least partially curing of the composition (C3a) and optionally of the composition (C2a);
(7) optionally applying at least one further composition (C4a) and at least partially curing of said composition (C4a);
(8) opening of the mold (MO) and removing the molded article comprising at least one structured and optionally coated surface;
(9) optionally post-treating of the article obtained after step (8).

The above-specified method is hereinafter also referred to as method of the invention and accordingly is a subject of the present invention. Preferred embodiments of the method of the invention are apparent from the description hereinafter and also from the dependent claims.

In light of the prior art it was surprising and unforeseeable for the skilled worker that the object on which the invention is based could be achieved by using mold parts which have at least one inner surface structured with a silicone layer or a composite comprising a substrate and a structured coating layer. The use of said mold results in an excellent transfer of the structure of the silicone layer or the composite to the molded article without negatively influencing the excellent demolding of the article after curing of the applied composition. Additionally, a simultaneous coating can be performed, thus resulting in textured and coated molded articles. Despite the texturization, the coating has an excellent adhesion to the textured molded article and is highly endurable with regard to bending of the article. The simultaneous texturization and coating renders subsequent and labor intensive post-treatment steps superfluous, thus resulting in a highly economic and environmentally friendly process. Since the structuring of the mold parts is performed by using structured layers which can be easily exchanged, the inventive process is highly versatile and easily adaptable with respect to the use of different structures without exchanging the mold as such. Additionally, the structured layer can be easily removed if said layer is worn out, thus rendering mold cleaning superfluous and prolonging the lifetime of the mold. Moreover, the structured layers can be produced far easier and cost-effective than structured metallic molds.

A further subject of the present invention is a structured molded article, produced by the inventive process.

### DETAILED DESCRIPTION

### Definitions

First of all a number of terms used in the context of the present invention will be described in more detail.

The term “three dimensional mold” is to be understood as referring to molds having a three dimensional inner cavity which is formed by at least two mold parts that can be moved relative to each other to open and close the mold. The inner cavity of the mold therefore has three dimensions, i.e. a length, width and depth. The mold can have a single cavity or multiple cavities. In multiple cavity molds, each cavity can be identical and form the same parts or can be unique and form multiple different geometries during a single cycle.

The term “inner surface (SU)” refers in accordance with the invention to the surface of the mold parts that comes into contact with composition (C2a) and also with the composition (C3a) and, optionally, further materials and compositions used in the process, during the production of the article. The inner surface (SU) is therefore facing the mold cavity which is formed when closing the mold parts.

In step (1) of the inventive process, at least one of the mold parts can be structured on its inner surface (SU) by using a micro- and/or nanostructured silicone containing layer. The term “micro- and/or nanostructured silicone containing layer” refers to a layer comprising micro- and/or nanostructures as well as at least one silicone compound. Such layers can, for example, be made of cured silicone elastomers or can be made of a material containing at least one silicone compound. In the latter case, such layers can be mono- or multilayers. In case of multilayers, at least the outer structured layer being adjacent to the inner cavity formed by the mold parts contains the at least one silicone compound.

The silicone containing layer used in step (1) contains a plurality of micro-scale and/or nano-scale surface elements. Microstructures here are structures—in terms of structure width and/or of structure height—having characteristics in the micrometer range. Nanostructures here are structures—in terms of structure width and/or of structure height—having characteristics in the nanometer range. Microstructures and nanostructures here are structures which have a structure width in the nanometer range and a structure height in the micrometer range or vice-versa. The terms “structure height” and “structure depth” are interchangeable here. The structure width and structure height of the respective surface are preferably determined by production of a cross section of the surface and determination of the structure height and structure width of said cross section by means of an optical microscopy.

In step (2) of the inventive process, the applied composition (C2a) is flashed off. This means the active or passive evaporation of solvents present in the composition (C2a), usually at a temperature which is higher than the ambient temperature, for example at 40 to 140° C. Flash off in step (2) can be performed by heating the mold prior or after application of the composition (C2a). The composition (C2a) is still flowable directly after application and at the start of the flashing off and can therefore form a uniform, smooth coating film during the flash off phase. The layer obtained from coating composition (C2a) after flashing, however, is not yet in the ready-to-use state. While it is indeed, for example, no longer fluid, it is still soft or tacky, and may have undergone only partial drying. In particular, the layer obtained from coating composition (C2a) is not yet crosslinked, as described in the following.

In process step (6) and optionally (7), the composition (C2a), the composition (C3a), and any further compositions (C4a) are at least partially crosslinked. This refers to the curing of these compositions, in other words the conversion of these compositions into the ready-to-use state, meaning a state in which the article comprising said cured compositions can be used as intended. The at least partially crosslinked compositions are, therefore, in particular no longer soft or tacky, having instead been conditioned to a solid coating film or solid article, respectively. Even on further exposure to crosslinking conditions as described later on below, the film or article no longer exhibits any substantial change in its properties such as hardness or adhesion to the substrate.

At least partial curing of the compositions (C2a), (C3a) and further compositions (C4a) used in the inventive process can be effected physically and/or chemically, depending on the components included, such as binders and crosslinking agents. The compositions are in particular at least partially cured chemically. Chemical curing comprehends thermochemical curing and actinic-chemical curing. Thermochemically curable compositions can be self-crosslinking and/or externally crosslinking. The mechanisms involved and also the binders and crosslinking agents (film-forming components) that can be used are described later on below. In the context of the present invention, “thermochemically curable” and, respectively, the term “thermochemical curing” refer to the crosslinking of the composition (formation of a cured composition) that is initiated by chemical reaction of reactive functional groups, with the possibility of energetic activation of this chemical reaction by means of thermal energy. Here, different functional groups, which are complementary to one another, may react with one another (complementary functional groups), and/or the formation of the cured composition is based on the reaction of autoreactive groups, these being functional groups which react with groups of their own kind. Examples of suitable complementary reactive functional groups and autoreactive functional groups are known from German patent application DE 199 30 665 A1, page 7, line 28 to page 9, line 24, for example. This crosslinking may be self-crosslinking and/or external crosslinking. Where, for example, the complementary reactive functional groups are already present in an organic polymer used as binder, as for example in a polyester, a polyurethane or a poly(meth)acrylate, the crosslinking involved is self-crosslinking. External crosslinking is involved if, for example, a (first) organic polymer or a first compound containing particular functional groups, hydroxyl groups for example, reacts with a conventional crosslinking agent, as for example with a polyisocyanate and/or with a melamine resin. The crosslinking agent therefore contains reactive functional groups which are complementary to the reactive functional groups present in the (first) organic polymer used as binder. In the case of external crosslinking in particular, the systems contemplated are the conventional multicomponent systems, especially two-component systems. In these systems, the components to be crosslinked, as for example the organic polymers as binders and the crosslinking agents, are present separately from one another in at least two components, which are not combined until shortly before the application. This form is selected when the components to be crosslinked react with one another effectively even at ambient temperatures or slightly elevated temperatures of 40 to 90° C., for example. A combination which may be stated by way of example is that of hydroxy-functional polyesters and/or polyurethanes and/or poly(meth)acrylates with free polyisocyanates as crosslinking agents. It is also possible for an organic polymer as binder to have not only self-crosslinking but also externally crosslinking functional groups and to then be combined with crosslinking agents.

In the at least partial curing of a composition labeled as being chemically curable, there will of course always be some physical curing, referring to the interlooping of polymer chains. The physical curing may even account for the major proportion. Nevertheless, a composition of this kind, if it comprises at least proportionally film-forming components that are chemically curable, is referred to as being chemically curable. It follows from the above that, according to the nature of the coating composition and the components it comprises, at least partial curing is brought about by different mechanisms, which of course also necessitate different curing conditions—in particular, different curing temperatures and curing times. In principle and in the context of the present invention it is the case that the at least partial curing of thermochemically curable two-component or three-component systems can be carried out at temperatures of, for example, 40 to 90° C., such as, in particular, 40 to 90° C., for a duration of 5 to 80 min, preferably 4 to 10 min. Accordingly it is the case that there is a pre-cure flashing phase at lower temperatures and/or for shorter times. A pre-cure flashing phase may run, for example, at 15 to 90° C. for a duration of, for example, 0.2 to 6 min, but in any case for shorter times and/or at lower temperatures than the subsequent curing.

All of the temperatures elucidated in the context of the present invention should be understood as the temperature of the molding tool in which the compositions are situated. It does not mean, therefore, that the compositions must themselves have the corresponding temperature.

The measurement methods to be employed in the context of the present invention for determining certain characteristic variables can be found in the Examples section. Unless explicitly indicated otherwise, these measurement methods are to be employed for determining the respective characteristic variable. Where reference is made in the context of the present invention to an official standard without any indication of the official period of validity, the reference is implicitly to that version of the standard that is valid on the filing date, or, in the absence of any valid version at that point in time, to the last valid version.

The term “poly(meth)acrylate” refers both to polyacrylates and to polymethacrylates. Poly(meth)acrylates may therefore be composed of acrylates and/or methacrylates and may comprise further ethylenically unsaturated monomers such as styrene or acrylic acid, for example.

All film thicknesses reported in the context of the present invention should be understood as dry film thicknesses. It is therefore the thickness of the cured film in each case. Hence, where it is reported that a coating material is applied at a particular film thickness, this means that the coating material is applied in such a way as to result in the stated film thickness after curing.

### Inventive Process:

The inventive process can be used to produce molded articles comprising at least one structured surface being optionally coated by at least one coating layer in a single molding process.

In the process of the invention, a molded article comprising at least one structured surface, i.e. a structured article, is produced. A “structured article” in the sense of the present invention is an article, preferably a workpiece or an assembled product, which comprises on at least a part of at least one surface a plurality of micro-scale and/or nano-scale surface elements. The structured article can optionally be coated with at least one coating on at least a part of at least one surface of said article during the molding process. In accordance with the invention, the texture and optionally coating of at least a part of at least one surface of the article is achieved by using at least one structured mold part and optionally at least one coating composition during the production of said article by the molding process. The coating of the structured article is provided by applying a coating composition (C2a) in step (2) on the at least one inner surface (SU) of at least one mold part comprising the structured silicone containing layer prior to application of the composition (C3a) in step (5).

The process according to the invention can either be a manual process or an automatic process. A manual process in the context of the present invention is a process where each process step is not linked to strict cycle times. Accordingly, in a manual process, a significant variation in the cycle time of each process step during multiple repetition of the process is present. However, the term “manual process” in the sense of the present invention does not mean that such processes cannot include automated process steps, an example being the use of robots. In contrast, an automatic process within the sense of the present invention is a process in which the individual process steps are linked to strict cycle times, in other words where, on multiple repetition of the process, the cycle time for a process step is identical or does not vary significantly.

### Step (1):

In step (1) of the inventive process, a closable, three dimensional mold (MO) having at least two mold parts which are movable relative to each other and which form a mold cavity is provided. In the context of the invention, the mold (MO) can also be formed of more than two mold parts, for example from three to ten mold parts. At least one micro- and/or nanostructured silicone containing layer is attached to at least a part of the inner surface (SU) of at least one of the mold parts. Thus, at least part of the inner surface (SU) of at least one of the mold parts is covered with a micro- and/or nanostructured silicone containing layer.

The closable, three dimensional mold (MO) having at least two mold parts can be a metallic mold, a polymeric mold or a mold comprising metallic and polymeric mold parts. In this respect, the mold parts are preferably selected from metallic mold parts, preferably steel, nickel or copper mold parts, very preferably steel mold parts, and/or from polymeric mold parts, preferably polyamide mold parts.

The attachment of the at least one micro- and/or nanostructured silicone containing layer to at least a part of the inner surface (SU) of at least one of the mold parts is facilitated by attaching the unstructured side of the silicone containing layer to at least a part of the inner surface (SU) of at least one of the mold parts such that the structured side of the silicone containing layer is adjacent to the mold cavity formed by the closed mold parts. The attached silicone containing layer can optionally be fixed to at least a part of the inner surface (SU) of the respective mold part by using various forms of temporary adhesion such as a differential in pressure caused by a surface temperature difference between the mold surface and the ambient air temperature at the surface of the structured silicone containing layer, a vacuum provided at the inner surface of the mold part at predetermined locations, robotic apertures, clamping means or magnetic forces. If an adhesive layer is used to attach the silicone containing layer, said adhesive layer is preferably removable, for example by applying heat and or solvents. In case of using clamping means, the mold parts may comprise suitable means for attaching said clamping means in such a way that the mold can be sufficiently closed. The fixing of the silicone containing layer to the respective mold part allows a stable mounting of said layer and/or composite to at least a part of the inner surface (SU) of the mold parts and avoids shifting of said layer during later process steps, for example during application of compositions (C2a), (C3a) or (C4a).

The at least one silicone containing layer is preferably selected from
(i) at least one micro- and/or nanostructured silicone layer (SiL) containing a plurality of micro-scale and/or nano-scale surface elements and/or
(ii) at least one composite (S1C1) comprising a substrate (S1) and at least one micro- and/or nanostructured coating layer (C1) containing at least one silicone compound and a plurality of micro-scale and/or nano-scale surface elements.

The term “micro- and/or nanostructured silicone layer (SiL)” refers to a layer made of silicone, for example cured silicone elastomers. Such micro- and/or nanostructured silicone layers can, for example, be obtained by pouring liquid crosslinkable silicone polymers onto a mold having the respective pattern formed, for example, by means of a laser, curing said silicone polymers and removing the formed micro- and/or nanostructured silicone layer. The silicone layer thus obtained will have—on one side—the positive or negative pattern of the mold used to prepare the silicone layer. Alternatively, the micro- and/or nanostructured silicone layer (SiL) can be obtained by structuring a cured silicone layer by means of a laser

Preparation of the Micro- and/or Nanostructured Silicone Layer (SiL):

Preferably, the micro- and/or nanostructured silicone layer (SiL) is obtained by
(i) providing a cured silicone layer, optionally on a carrier material (CM1), and
(ii) structuring the surface of the cured silicone layer by means of a laser to provide the micro- and/or nanostructured structured silicone layer (SiL).

Suitable carrier materials (CM1) are selected from the group consisting of textiles, films of polyethylene terephthalate (PET), polyethylene naphthalate (PEN), polybutylene terephthalate, polyethylene, polypropylene, polyamide or polycarbonate, preferably PET or PEN films, glass fiber fabrics, composites made of glass fibers and suitable polymeric materials, papers, aluminum, steel, magnetic steel or other iron alloys. The use of said carrier material (CM1) allows to better handle and attach the resulting structured silicone layer (SiL), especially in cases where structured silicone layers (SiL) having only small thicknesses are used. The attachment of the cured silicone layer to the carrier material (CM1) can be facilitated by directly curing silicone elastomers on the carrier material (CM1) or by attaching the previously cured silicone layer to the carrier material (CM1). In the latter case, the carrier material and/or the cured silicone layer might comprise an adhesive layer to improve the adhesion between the cured silicone layer and the carrier material (CM1).

The cured silicone layer is preferably obtained by (i) addition crosslinking of at least one compound having radicals with aliphatic carbon-carbon multiple bonds and at least one organopolysiloxane having Si-bonded hydrogen atoms and/or at least one organopolysiloxane having SiC-bonded radicals with aliphatic carbon-carbon multiple bonds and Si-bonded hydrogen atoms in the presence at least one hydrosilylation catalyst or (ii) condensation crosslinking of at least one polyorganosiloxane having condensable end groups and/or at least one organosilicone compound optionally having at least three hydrolyzable groups bonded to silicone per molecule in the presence at least one condensation catalyst.

Addition-crosslinking siliconee compositions used to prepare the cured silicone layer in step (i) therefore comprise
at least one compound having radicals with aliphatic carbon-carbon multiple bonds (A) and at least one organopolysiloxane having Si-bonded hydrogen atoms (B),
   and/or
at least one organopolysiloxane having SiC-bonded radicals with aliphatic carbon-carbon multiple bonds and Si-bonded hydrogen atoms (C)
   and
at least one hydrosilylation catalyst (D).

Suitable crosslinked siliconee rubbers which crosslink by addition reaction are room temperature crosslinking two-component systems, known as addition-crosslinking RTV-2 siliconee rubbers. Addition-crosslinking RTV-2 siliconee rubbers are obtained by crosslinking of organopolysiloxanes substituted by polyethylenically unsaturated groups, preferably vinyl groups, with organopolysiloxanes polysubstituted by Si—H groups, in the presence of hydrosilylation catalysts, preferably platinum catalysts.

Preferably, one of the components consists of dialkylpolysiloxanes of the R₃SiO[—SiR₂O]ₙ—SiR₃ structure where generally with 1 to 4 carbon atoms in the alkyl radical, where some or all of the alkyl radicals may be replaced by aryl radicals such as the phenyl radical, and one of the terminal R radicals at one or both ends is replaced by a polymerizable group such as the vinyl group. It is equally possible for some R radicals in the siloxane chain, also in combination with the R radicals of the end groups, to be replaced by polymerizable groups. Preference is given to using linear vinyl end-capped polydimethylsiloxanes of the CH₂═CH₂—R₂SiO[—SiR₂O]ₙ—SiR₂—CH₂═CH₂ structure as component (A) having a viscosity of 0.01 to 500,000 Pa*s, more preferably 0.1 to 100,000 Pa*s, in each case at 25° C.

The second component comprises an Si—H-functional crosslinker and preferably contains Si-bonded hydrogen in a range from 0.04 to 1.7 percent by weight (wt %), based on the total weight of the organopolysiloxane (B). The polyalkylhydrosiloxanes typically used are copolymers formed from dialkylpolysiloxanes and polyalkylhydrosiloxanes with the general formula R′₃SiO[—SiR₂O]ₙ—[SiHRO]ₘ—SiR′₃ where m with the proviso that at least two SiH groups must be present, where R′ may be defined as H or R. There are accordingly crosslinkers with pendant and terminal SiH groups, while siloxanes where R′ is H which possess only terminal SiH groups can also be used for chain extension. Particularly preferred is the use of low molecular mass, SiH-functional compounds such as tetrakis(dimethylsiloxy)silane and tetramethylcyclotetrasiloxane, and also of SiH-containing siloxanes of higher molecular mass, such as poly(hydrogen-methyl)siloxane and poly(dimethylhydrogenmethyl)siloxane with a viscosity at 25° C. of 10 to 20,000 mPa*s, or similar SiH-containing compounds in which some of the methyl groups have been replaced by 3,3,3-trifluoropropyl or phenyl groups.

Examples of the third component (C) are those comprising SiO_{4/2}, R¹₃ SiO_{1/2}, R¹₂R²SiO_{1/2}, and R¹₂HSiO_{1/2} units, known as MP resins, and these resins may additionally contain R¹SiO_{3/2} and R¹₂ SiO units, and also linear organopolysiloxanes substantially consisting of R¹₂R²SiO_{1/2}, R¹₂ SiO, and R¹HSiO units, with R¹ and R² meeting the aforementioned definition. The organopolysiloxanes (C) preferably possess an average viscosity of 0.01 to 500,000 Pa*s, more preferably 0.1 to 100,000 Pa*s, in each case at 25° C.

The addition-crosslinking silicone composition—based on its total weight—customarily contains 30 to 95 wt %, preferably 30 to 80 wt %, and more preferably 40 to 70 wt % of component (A), 0.1 to 60 wt %, preferably 0.5 to 50 wt %, and more preferably 1 to 30 wt % of component (B) and 30 to 95 wt %, preferably 30 to 80 wt %, more preferably 40 to 70 wt % of component (C).

The hydrolysation catalyst (D) may be a platinum group metal, as for example platinum, rhodium, ruthenium, palladium, osmium, or iridium, or an organometallic compound thereof, or a combination thereof. Examples of component (D) are compounds such as hexachloroplatinic(IV) acid, platinum dichloride, platinum acetylacetonate, and complexes of these compounds encapsulated in a matrix or in a core/shell-like structure. The platinum complexes with low molecular weight of the organopolysiloxanes include 1,3-diethenyl-1,1,3,3-tetramethyldisiloxane complexes with platinum. Other examples are platinum-phosphite complexes or platinum-phosphine complexes. The amount of component (D) may be between 0.1 and 1000 parts per million (ppm), 0.5 and 100 ppm, or 1 and 25 ppm of the platinum group metal, depending on the total weight of the components.

Condensation-crosslinking silicone compositions used in step (i) to prepare the cured silicone layer preferably contain

a) at least one organopolysiloxane having condensable end groups and/or
b) at least one organosilicone compound optionally having at least three hydrolyzable groups bonded to silicone per molecule, and
c) at least one condensation catalyst.

Suitable crosslinking silicone rubbers which crosslink by condensation reaction are, for example, room temperature crosslinking one-component systems, also known as RTV-1 silicone rubbers. The RTV-1 silicone rubbers are organopolysiloxanes with condensable end groups which crosslink in the presence of catalysts by condensation at room temperature. The most commonly used organopolysiloxanes are dialkylpolysiloxanes of the R₃SiO[—SiR₂O]ₙ—SiR₃ structure with a chain length of n>2. The alkyl radicals R may be the same or different and generally have 1 to 4 carbon atoms and may optionally be substituted. Some of the alkyl radicals R may also be replaced by other radicals, preferably by aryl radicals, which are optionally substituted, in which case some of the alkyl (aryl) groups R are exchanged for groups capable of condensation crosslinking, for example alcohol, acetate, amine or oxime radicals.

Further suitable crosslinked silicone rubbers which crosslink by condensation reaction are room temperature crosslinking two-component systems, also known as RTV-2 silicone rubbers. RTV-2 silicone rubbers are obtained by means of condensation crosslinking of organopolysiloxanes polysubstituted by hydroxyl groups in the presence of silicic esters. The crosslinkers used may also be alkyl silanes with alkoxy, oxime, amine or acetate groups.

Examples of the polydialkylsiloxanes present in RTV-1 and RTV-2 silicone rubber are those of the formula (OH)R₂SiO[—SiR₂O]ₙ—SiR²(OH) with a chain length of n>2, where the alkyl radicals R may be the same or different, generally contain 1 to 4 carbon atoms and may optionally be substituted. Some of the alkyl radicals R may also be replaced by other radicals, preferably by aryl radicals, which are optionally substituted. The polydialkylsiloxanes preferably contain terminal OH groups which crosslink with the silicic esters or the alkylsilane/tin (titanium) catalyst system at room temperature.

Examples of the alkylsilanes which have hydrolyzable groups and are present in RTV-1 and RTV-2 siliconee rubbers are those of the formula RₐSi(OX)₄₋ₐ where a=1 to 3 (preferably 1), and X is defined as R″ (alkoxy crosslinker), C(O)R″ (acetate crosslinker), N═CR″2 (oxime crosslinker) or NR″2 (amine crosslinker), where R″ is a monovalent hydrocarbon radical having 1 to 6 carbon atoms.

The crosslinking is catalyzed by means of suitable catalysts, for example tin or titanium catalysts or a mixture of alkylsilane and tin or titanium catalyst.

The addition or condensation crosslinking silicone compositions may furthermore comprise additives and assistants, such as, for example, IR absorbers, dyes, dispersants, antistatic agents, plasticizers and abrasive particles. However, the amount of such additives should as a rule not exceed 30% by weight, based on the amount of all components of the respective silicone composition.

The cured silicone layer obtained after step (i) can also be composed of a plurality of individual layers, preferably individual silicone layers. These part-layers may be of the same, approximately the same or different material composition. The cured silicone layer can optionally furthermore have a top layer with a thickness of not more than 300 μm. The composition of such a top layer can be chosen with regard to optimum engravability and mechanical stability, while the composition of the layer underneath is chosen with regard to optimum hardness or resilience. The top layer must be either itself laser-engravable or must at least be removable together with the layer underneath in the course of the laser engraving.

Step (i) can be performed by dissolving or dispersing all components of the addition or condensation crosslinking silicone composition in a suitable solvent and pouring said dispersion or solution on a substrate. If a carrier material is used, said dispersion or solution is preferably poured on the carrier material (CM1) previously mentioned. In the case of multi-layer elements, a plurality of layers can be cast one on top of the other in a manner known in principle. If a “wet-in-wet” method is employed, the layers bond well to one another. A top layer can also be poured on. In the end, all layers are cured, preferably by heating. Alternatively, the individual layers can be cast, for example, on temporary substrates and cured and the obtained layers subsequently bonded to one another by lamination. After the casting, a cover sheet for protecting the starting material from damage can also optionally be applied.

In step (ii), the surface of the cured silicone layer obtained in step (i) is structured by means of a laser. If a carrier material (CM) is used, the surface of the cured silicone layer not being in contact with the carrier material (CM) is structured by means of a laser. If no carrier material (CM) is used, preferably only one surface of the cured silicone layer is structured by means of a laser. Preconditions for the structuring by means of laser engraving are that laser radiation is absorbed by the cured silicone layer and that a certain threshold energy of the laser beam is introduced into the polymer layer. The absorption of the recording layer for the chosen laser radiation should be as high as possible (the mean power density is typically >10 kW/cm², preferably >100 kW/cm²).

In the laser structuring of the cured silicone layers, large amounts of cured siliconee material must be removed. Powerful lasers are therefore preferred. IR lasers in particular are suitable for laser engraving. However, it is also possible to use lasers having shorter wavelengths, provided the laser is of sufficient intensity. For example, a frequency-doubled (532 nm) or frequency-tripled (355 nm) Nd-YAG laser can be used, or else an excimer laser (248 nm for example). The laser-engraving operation may utilize for example a CO₂ laser having a wavelength of 10,640 nm. It is particularly preferable to use lasers having a wavelength in the range from 600 to 2,000 nm. Nd-YAG lasers (1,064 nm), IR diode lasers or solid-state lasers can be used for example. Nd/YAG lasers are particularly preferred since a considerably higher resolution can be obtained so that substantially finer structures can be engraved into the surface of the cured silicone layer. The image information to be engraved is transferred directly from the lay-out computer system to the laser apparatus. The lasers can be operated either continuously or in a pulsed mode.

For engraving the structure, the cured silicone layer is moved relative to the laser or to the laser component emitting the laser beam or the laser pulse (also referred to below as “laser” for short) and the laser is electronically modulated according to the movement, with the result that the desired pattern is produced.

For example, the laser-engravable layer or a suitable layer composite can be applied to a cylinder, for example of plastic, glass fiber-reinforced plastic, metal or foam, for example by means of self-adhesive tape, reduced pressure, clamping apparatuses or magnetic forces. The cylinder comprising the attached cured silicone layer is afterwards rotated and optionally moved in the axial direction while the laser is modulated under electronic control according to the movement of the cylinder. However, it is also possible for the cured silicone layer to be arranged in a planar manner. In this case, the cured silicone layer and laser are moved relative to one another in the plane of the cured silicone layer while the laser is modulated under electronic control according to the relative movement. Additionally, the cured silicone layer can also be attached to at least part of the inner surface of the mold part(s) prior to the engravement process. In this case, the mold part and the laser are moved relative to on another. After the engravement process, the structured silicone layer can be washed with a cleaning agent to remove engraving residues present after step (ii) on the surface.

The total thickness of the micro- and/or nanostructured silicone layer (SiL) after step (ii) of the process is preferably 1 to 10 mm, preferably of 0.5 to 3 mm, very preferably 2 to 3 mm. The total thickness can, for example, be determined by production of a cross section of the silicone layer (SiL) and determination of the thickness of said cross section by means of an optical microscopy. The total thickness is thereby corresponding to the maximum thickness of the silicone layer (SiL) measured at the protruding surface elements.

Production of Micro- and/or Nanostructured Composite (S1C1):

Instead or next to the structured silicone layer (SiL) previously described, a micro- and/or nanostructured composite (S1C1) can be used within the inventive process. Said micro- and/or nanostructured composite (S1C1) is preferably obtained by
(I) applying a radiation-curable coating composition (C1a) to at least a part of the surface of a substrate (S1) to provide a composite (S1C1a);
(II) at least partially embossing the coating composition (C1a) applied at least partly to the surface of the substrate (S1) by means of at least one embossing tool (E1) comprising at least one embossing mold (e1);
(III) at least partially curing the at least partially embossed coating composition (C1a) applied at least partially to a substrate (S1) which throughout the duration of the at least partial curing is in contact with the at least one embossing mold (e1) of the embossing tool (E1);
(IV) removing the composite (S1C1) from the embossing mold (e1) of the embossing tool (E1) to provide the at least partially embossed and at least partially cured composite (S1C1), or vice versa.

The term “embossing” refers to a process where at least part of the surface of the coating composition (C1a) after step (II) or at least part of the surface of at least partially cured coating layer (C1) after step (III) exhibits an embossed structure. In this case at least a certain area of the coating composition (C1a) or coating layer (C1) is furnished with an embossed structure. Preferably, the entire surface of the coating composition (C1a) or the coating layer (C1) is furnished with an embossed structure.

In step (I), a radiation-curable coating composition (C1a) is applied to a at least part of the surface of a substrate (S1). The substrate (S1) thus constitutes a carrier material for the coating composition (C1a) or the cured coating layer (C1), respectively. Further layers, for example adhesion promoting layers preferably being permeable to UV radiation can be present between (S1) and (C1) in the composite (S1C1). It is favorable, however, if no further layer is present between (S1) and (C1) in the composite (S1C1). The substrate (S1) or, if a coated substrate is used, the layer located on the surface of the substrate (S1) and being in contact with the coating composition (C1a) consists preferably of at least one thermoplastic polymer, selected more particularly from the group consisting of polymethyl (meth)acrylates, polybutyl (meth)acrylates, polyethylene terephthalates (PET), polybutylene terephthalates (PBT), polyvinylidene fluorides, polyvinyl chlorides, polyesters, including polycarbonates and polyvinyl acetate, preferably polyesters such as PBT and PET, polyamides, polyolefins such as polyethylene, polypropylene, polystyrene, and also polybutadiene, polyacrylonitrile, polyacetal, polyacrylonitrile-ethylene-propylene-diene-styrene copolymers (A-EPDM), polyetherimides, phenolic resins, urea resins, melamine resins, alkyd resins, epoxy resins, polyurethanes, including thermoplastic polyurethane (TPU), polyether ketones, polyphenylene sulfides, polyethers, polyvinyl alcohols, and mixtures thereof. Particularly preferred substrates or layers on the surface thereof are polyolefins such as, for example, PP (polypropylene), which may alternatively be isotactic, syndiotactic or atactic and may alternatively be unoriented or oriented through mono- or biaxial drawing, SAN (styrene-acrylonitrile copolymers), PC (polycarbonates), PMMA (polymethyl methacrylates), PBT (poly(butylene terephthalate)s), PA (polyamides), ASA (acrylonitrile-styrene-acrylic ester copolymers) and ABS (acrylonitrile-butadiene-styrene copolymers), and also their physical mixtures (blends). Particularly preferred are PP, SAN, ABS, ASA and also blends of ABS or ASA with PA or PBT or PC. Especially preferred are PET, PBT, PP, PE, and polymethyl methacrylate (PMMA) or impact-modified PMMA. Especially preferred is a polyester, most preferably PET, for use as material for the substrate (S1). Alternatively, the substrate (S1) itself—optionally in spite of a layer of at least one of the aforementioned polymers applied thereto—may be made of a different material such as glass, ceramic, metal, paper and/or fabric. In that case the substrate (S1) is preferably a plate and may be used, for example, in a roll-to-plate (R2P) embossing apparatus. The permeability of the substrate (S1) for radiation is preferably harmonized with the absorption maximum of the least one photoinitiator used in coating composition (C1a).

The thickness of the substrate (S1) is preferably 2 μm up to 5 mm. Particularly preferred is a layer thickness of 25 to 1000 μm, more particularly 50 to 300 μm.

The substrate (S1) is preferably a film, more preferably a film web, very preferably a continuous film web. In that case the substrate (S1) may be used preferably in a roll-to-roll (R2R) embossing apparatus. In the sense of the present invention, the term “continuous film” or “continuous film web” refers preferably to a film having a length of 100 m to 10 km.

The coating composition (C1a) preferably comprises

a) at least one crosslinkable polymer and/or oligomer,
b) at least one reactive diluent,
c) at least one photoinitiator and
d) optionally at least one additive,
wherein the coating composition (C1a) contains at least one silicone compound, preferably selected from crosslinkable silicone-containing polymers and/or oligomers. The use of crosslinkable silicone-containing polymers and/or oligomers ensures that the silicone compound is chemically bound within the at least partially cured coating (C1), thus minimizing the transferal of the silicone compound from the coating (C1) to the composition (C3a) and further optional compositions and materials during the inventive process and therefore rendering post-cleaning or sanding processes to remove said silicone compound superfluous.

The term “silicone compound or silicone-containing compound” in the sense of the present invention refers to compounds comprising at least one silicone atom. If the at least one silicone compound is a crosslinkable silicone-containing polymer and/or oligomer, the at least partially cured coating (C1) contains the silicone compound in polymerized form, i.e. in a form which has undergone respective crosslinking reactions with further crosslinkable polymers and/or oligomers and/or reactive diluent during the at least partial curing of the coating composition (C1a). However, it is also possible within the present invention to use a silicone compound selected from silicone-containing reactive diluents or silicone-containing additives.

The at least one crosslinkable polymer and/or oligomer is preferably selected from (meth)acrylated oligomer or polymer compounds, urethane (meth)acrylates, vinyl (meth)acrylates, epoxy (meth)acrylates, polyester (meth)acrylates, poly(meth)acrylates, polyether (meth)acrylates, polyether (meth) acrylates, olefin (meth) acrylates, (meth)acrylated oils, silicone (meth)acrylates and mixtures thereof, preferably urethane (meth)acrylate oligomers and silicone (meth)acrylates. The term “oligomer” refers to relatively low molecular weight compounds consisting of few, typically less than 30 monomer units. The monomer units may be structurally identical or similar, or they can be different from each other. Oligomeric compounds are typically liquid at room temperature and ambient pressure whereby the dynamic viscosity is preferably less than 500 Pa*s and more preferably less than 200 Pa*s at 23° C. measured according to DIN EN ISO 2555 (Brookfield method). The term “crosslinkable” refers to polymers or oligomers having on average at least one, preferably at least two, pending unsaturated groups capable of forming free radicals for crosslinking reactions. The cross-linkable oligomer and/or polymer compounds are preferably soluble in the one or more reactive diluents.

The coating composition (C1a) preferably comprises crosslinkable polymers and/or oligomers selected from urethane (meth)acrylate oligomers and silicone (meth)acrylate oligomers, especially urethane (meth)acrylate oligomers and silicone (meth)acrylate oligomers comprising on average 0.5 to 3 unsaturated groups. Silicone (meth)acrylate oligomers or polymers useful in the present invention can be typically prepared by condensation reaction between (meth)acrylic acid and hydroxyfunctional silicones (e. g. α,ω-polydimethylsilicone diols) or by reaction of epoxyfunctional silicones (e.g. polydimethylsilicones comprising pendant epoxy-groups) with (meth)acrylic acid. Due to their silicone backbone silicone acrylates tend to improve the elasticity and elongation of the structured surfaces but impair their tensile strength and robustness. Higher functional silicone (meth)acrylates are often used due to their low surface energy properties. Examples of useful silicone (meth)acrylates include those commercially available from Sartomer Co. under the trade name SARTOMER (e.g., SARTOMER CN 9800), UCB Radcure Inc. under the EBECRYL trade name (e. g. EBECRYL 350, EBECRYL 1360), from Shin-Etsu Silicones Europe B.V. under the product name X-22 (e.g., X-22-164, X-22-164A) and from Evonik Industries under the trade name TEGO RAD (e.g. TEGO RAD 2500, TEGO RAD 2800).

According to a first particularly preferred embodiment of the coating composition (C1a), said coating composition comprises—based on the total weight of all crosslinkable polymers and/or oligomers present in the coating composition (C1a)—at least 50% by weight, more preferably at least 90% by weight, very preferably 100% by weight of at least one silicone (meth)acrylate oligomer, preferably at least one silicone (meth)acrylate oligomer comprising on average 0.5 to 3 unsaturated groups.

According to a second particularly preferred embodiment of the coating composition (C1a), said coating composition comprises at least one urethane (meth)acrylate and at least one silicone (meth)acrylate, wherein the silicone (meth)acrylate is present in a total amount of 0.1 to 25% by weight, preferably 0.5 to 20% by weight, very preferably 0.8 to 12% by weight, based in each case on the total amount of all crosslinkable polymers and/or oligomers present in the coating composition (C1a). Preferred coating compositions (C1a) comprise the at least one crosslinkable polymer and/or oligomer in a total amount of 5 to 45 weight %, more preferably 8 to 40% by weight, very preferably 9 to 35 weight %, based on the total weight of the coating composition (C1a).

Suitable reactive diluents are polymerizable with the oligomer and/or polymer compounds to form a composite (S1C1) comprising a copolymerized elastomeric network of the cured coating composition (C1a). The term reactive diluent refers to low weight monomers which are able to participate in a polymerization reaction to form a polymeric material. The weight average molecular weight M_{w} of such monomer compounds preferably is less than 1,000 g/mol and more preferably less than 750 g/mol, as determined by GPC.

Preferably, the reactive diluents are free-radically polymerizable monomers and include, for example, ethylenically-unsaturated monomers such as (meth)acrylates, styrene, vinyl acetate and mixtures thereof. Preferred monomers include (meth)acryloyl-functional monomers such as, for example, alkyl (meth)acrylates, aryloxyalkyl (meth)acrylates, hydroxyalkyl (meth)acrylates, N-vinyl compounds and combinations thereof. Suitable monomers are known to the person skilled in the art and are, for example, listed in WO 2012/006207 A1.

Particularly preferred master coatings (C1a) comprise at least one multifunctional ethylenically unsaturated monomer, i.e. a compound having at least two polymerizable double bonds in one molecule, as reactive diluent in order to increase the crosslinking density. Representative examples of such multifunctional monomers are listed, for example, in WO 2012/006207 A1. Especially preferred reactive diluents are selected from hexane diol diacrylate and/or compounds comprising at least two, preferably precisely three, structural units which may be different from each other or identical of the general formula (I)

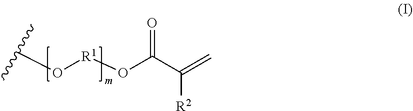

wherein
the radicals R¹, independently of each other, are C₂-C₈ alkylene groups, very preferably C₂ alkylene groups,
the radicals R², independently of each other, are H or methyl, and
the parameters m, independently of each other, are an integral number in a range from 1 to 15, very preferably from 1 to 4 or 2 to 4, but with the proviso that in at least one of the structural units of the formula (I) the parameter m is at least 2, preferably exactly 2.

All structural units of general formula (I) are attached via the symbol

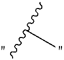

to the backbone of said reactive diluent. This bonding preferably takes place preferably via a linking of the oxygen atom of the radical —[O—R¹]ₘ— to a carbon atom of the backbone of the component. Thus, the at least two, preferably the at least three, structural units of general formula (I) are present within a single component, namely the reactive diluent b). Suitable backbones are, for example, selected from neopentyl glycol, trimethylolpropane, trimethylolethane or pentaerythritol.

Said compound preferably comprises a total number of ether groups of the general formula “—O—R¹” in a range from 4 to 18, more preferably in a range from 5 to 15, very preferably in a range from 6 to 12. Said compound preferably has a molecular weight (Mₙ) in the range from 300 to 2,000 g/mol, more preferably from 400 to 1,000 g/mol, as determined by GPC.

Especially preferred compounds comprising at least two structural units of general formula (I) are (meth)acrylates of neopentyl glycol, trimethylolpropane, trimethylolethane or pentaerythritol with a total of 4-fold to 20-fold or of 4-fold to 12-fold alkoxylation, such as ethoxylated, propoxylated or ethoxylated and propoxylated, and more particularly exclusively ethoxylated, neopentyl glycol, trimethylolpropane, trimethylolethane or pentaerythritol. The most preferred are corresponding (meth)acrylates derived from alkoxylated trimethylolpropane.

The coating composition (C1a) preferably comprises a total amount of 40 to 95 weight %, preferably of 55 to 80 weight %, based on the total weight of the coating composition (C1a) of the at least one reactive diluent, preferably of hexane diol diacrylate and/or (meth)acrylates derived from 6-fold ethoxylated trimethylolpropane.

The at least one photoinitiator comprised in the coating composition (C1a) is preferably selected from phosphine oxides, benzophenones, α-hydroxyalkyl aryl ketones, thioxanthones, anthraquinones, acetophenones, benzoins and benzoin ethers, ketals, imidazoles or phenylglyoxylic acids and mixtures thereof. Particularly preferred photoinitiators are diphenyl(2,4,6-trimethylbenzoyl)phosphine oxide, ethyl (2,4,6-trimethylbenzoyl)phenylphosphinate, phenylbis(2,4,6-trimethylbenzoyl)phosphine oxide, benzophenone, 1-benzoylcyclohexan-1-ol, 2-hydroxy-2,2-dimethylacetophenone and 2,2-dimethoxy-2-phenylacetophenone and mixtures thereof. The at least one photoinitiator is preferably present in a total amount of 0.01 to 15 weight %, preferably of 0.5 to 10 weight %, based on the total weight of the coating composition (C1a).

The coating composition (C1a) can further comprise at least one additive. Said additive does preferably not comprise crosslinkable silicone-containing polymers and/or oligomers as well as urethane (meth)acrylate oligomers and/or polymers and is preferably selected from the group consisting of flow control agents, surface-active agents such as surfactants, wetting agents and dispersants, and also thickeners, thixotropic agents, plasticizers, lubricity and antiblocking additives, and mixtures thereof. Examples of commercially available additives are the products Efka® SL 3259, Byk® 377, Byk® 394, Byk-SILCLEAN 3710, Silixan® A250, Novec FC 4430 and Novec FC 4432. Suitable total amounts of the at least one additive are, for example, 0.01 to 5 weight %, 0.2 or 0.5 to 3 weight %, based on the total weight of the coating composition (C1a).

A particularly preferred coating composition (C1a) thus comprises—based on the total weight of (C1a)—the following components:
9 to 35 weight % of a mixture of exactly one urethane (meth)acrylate oligomer comprising on average 2 unsaturated groups and exactly one silicone (meth)acrylate comprising on average 0.5 to 3 unsaturated groups, wherein the mixture comprises a weight ratio of the urethane (meth)acrylate to the silicone (meth)acrylate of 10:1 to 8:1,
55 to 83 weight % of hexane diol diacrylate and/or (meth)acrylates derived from 6-fold ethoxylated trimethylolpropane (i.e. compounds comprising three structural units of general formula (I)),
1 to 10 weight % of ethyl (2,4,6-trimethylbenzoyl)phenylphosphinate and/or 1-benzoylcyclohexan-1-ol and
0 or 0.5 to 3 weight % of a lubricity additive and/or an antiblocking additive.

A further particularly preferred coating composition (C1a) thus comprises—based on the total weight of (C1a)—the following components:
9 to 35 weight % of exactly one silicone (meth)acrylate comprising on average 2 unsaturated groups,
55 to 83 weight % of hexane diol diacrylate and/or (meth)acrylates derived from 6-fold ethoxylated trimethylolpropane (i.e. compounds comprising three structural units of general formula (I)),
1 to 10 weight % of ethyl (2,4,6-trimethylbenzoyl)phenylphosphinate and/or 1-benzoylcyclohexan-1-ol and
0 or 0.5 to 3 weight % of a lubricity additive and/or an antiblocking additive

The double bond conversion of the at least partially cured coating layer (C1) obtained from (C1a) is preferably at least 70%, more preferably at least 75%, more preferably still at least 80%, very preferably at least 85%, more particularly at least 90%.

The coating composition (C1a) may comprise at least one further component (e), different from the components (a) to (d), such as, for example, fillers, pigments, thermally activatable initiators such as, for example, potassium peroxodisulfate, dibenzoyl peroxide, cyclohexanone peroxide, di-tert-butyl peroxide, azobisisobutyronitrile, cyclohexylsulfonyl acetyl peroxide, diisopropyl percarbonate, tert-butyl peroctoate or benzopinacol, cumene hydroperoxide, dicumyl peroxide, tert-butyl perbenzoate, silylated pinacols, alkoxyamines, and organic solvents, and also stabilizers. Preferably, however, there are no organic solvents included in coating composition (C1a). The coating composition (C1a) may comprise the at least one component (e) in a total amount of 0 to 10 weight %, preferably 0 to 5 weight %, more preferably 0 to 1 weight %, based on the total weight of the coating composition (C1a).

Coating composition (C1a) can be a solvent-based or a solid coating composition. In order to facilitate rapid curing and to prevent generation of high amounts of evaporating solvents upon curing, the coating composition (C1a) is preferably a solid coating composition. Thus, coating composition (C1a) favorably comprises a total amount of less than 10 weight %, preferably less than 5 weight %, more preferably less than 1 weight %, very preferably 0 weight % or no solvents, based on the total weight of the coating composition (C1a). Thus, coating composition (C1a) favorably has a solids content of 75 to 100 weight %, based on the total weight of the coating composition (C1a), as determined according to DIN EN ISO 3251:2008-06 at 125° C. and 60 min. Moreover, it favorably comprises a total amount of compounds (a), (b), (c) and optionally (d) of 90 to 100 weight %, preferably 95 to 100 weight %, more preferably 99 to 100 weight % based on the total weight of the coating composition (C1a). Most preferably, coating composition (C1a) consists of compounds (a), (b), (c), and optional (d).

The coating composition (C1a) preferably contains no thiols, and especially no trimethylolpropane tris(3-mercaptopropionate).

A suitable apparatus for preparing composite (S1C1) is, for example, disclosed in WO 2019/185833 A1 in connection with composite (F1B1).

The embossing tool (E1) used in step (II) can either be made of polymeric material or can be a metallic embossing tool and is preferably reusable, i.e. it can be employed repeatedly for transferring at least one embossed structure to the coating composition (C1a). The embossing tool (E1) has a “negative structure” (“negative form”), i.e., the mirror image of the embossed structure which in step (II) of the method of the invention is transferred onto the coating composition (C1a) and, after implementation of step (III), onto the coating layer (C1). The embossing tool (E1) comprises at least one embossing mold (e1). Said embossing mold (e1) can be a polymeric embossing mold (e1) or a metallic embossing mold (e1), preferably a metallic embossing mold (e1). Thus, the embossing tool (E1) comprising at least one embossing mold (e1) used in step (II) is preferably selected from metallic embossing tools, preferably nickel embossing tools, more particularly nickel embossing tools which contain small amounts of phosphorus.

The embossing tool (E1) may preferably be an embossing calender, which preferably comprises a grid application mechanism, more preferably a grid roll mechanism. This calender possesses counter-rotating rolls, preferably arranged above one another in the height direction with a certain spacing, and the composite (S1C1a) to be provided with an embossed structure is supplied to the rolls and is guided through the roll nip which forms, with the nip width being variably adjustable. The grid roll mechanism here preferably comprises a first roll functioning as the embossing tool (E1) and containing embossing molds (e1) having the negative form of the embossed structure to be embossed into the surface of the composite (S1C1a). The second roll serves as an impression or pressing roll. Thus, the at least partial embossing in step (II) preferably takes place at the level of the roll nip which is formed by the two mutually opposing rolls, rotating counter-directionally or in the same direction, where the at least one embossing mold (e1) of the at least one embossing tool (E1) is facing the coating composition (C1a) of the composite (S1C1a).

In step (IV), the embossed composite (S1C1) is removed from the embossing molds (e1) of the embossing tool (E1), thus resulting in the composite (S1C1) comprising a micro- and/or nanostructured coating layer (C1). Said removal from the embossing tool can, for example, be performed by peeling the at least partially embossed coating material comprising the substrate (S1) from the embossing tool (E1) or vice versa. Peeling can either be done manually or be using commonly known mechanical dividing means.

Alternatively, the removal from the embossing tool (E1) can comprise the following steps:
(V) applying at least one adhesive layer (AL) on the surface of substrate (S1) not being in contact with the at least partially embossed coating layer (C1), and
(VI) removing, preferably peeling, the composite (ALS1C1) from the embossing tool (E1) or vice versa.

The application of the adhesive layer (AL) and the removal of the composite (ALS1C1) can either be done manually or by using commonly known dividing means.

The adhesive layer (AL) can, for example, be a laminating adhesive, such as a polyacrylate or a polyacrylate-based adhesive. However, the adhesive layer (AL) is preferably a self-adhesive layer or a multi-layer construction. Such multi-layer constructions comprise, for example, a middle polymer layer (PL) also called in-liner, which is coated with an adhesive (AH) on both surfaces. Said adhesive (AH) may each be a polyacrylate or a polyacrylate-based adhesive. In principle, any type of polymer can be used to prepare the middle polymer layer (PL). Examples of such polymers are poly(meth)acrylates, polyesters such as PET and/or PBT, polyvinylidene fluorides, polyvinylchlorides, polyamides and/or polyolefins. In particular, a polyester such as PET can be used. The layer thickness of the polymer layer (PL) may be in a range from 5 to 55 μm, preferably from 6 to 50 μm, more preferably from 7 to 40 μm, in particular from 8 to 30 μm. Each adhesive (AH) may initially be covered by a release liner, such as silicone paper, for better handling. However, prior to use as an adhesive layer (AL) in the step (V one of the two release liners is removed. The other release liner is preferably removed in a later step of the inventive process, more preferably before attaching the composite (S1C1) to the at least part of the inner surface of at least one of the mold parts.

### Properties of the Silicone Containing Layer, Preferably the Silicone Layer (SiL) and the Composite (S1C1):

The micro- and/or nanostructured silicone containing layer, preferably the silicone containing layer (SiL) and composite (S1C1), comprise a plurality of micro-scale and/or nano-scale surface elements. The size of a specific micro-scale or nano-scale surface element, respectively, is defined as its maximum extension in any direction parallel to the surface, i.e., for example, as the diameter of a cylindrical surface element or the diagonal of the base surface of a pyramidal surface element. In case of surface elements having a macro-scale extension in one or more directions within the surface (or parallel to the surface) and a micro- or nano-scale extension in one or more other directions within the surface, the term size of the surface elements refers to the micro- and/or nano-scale extension of such surface elements. The length of a specific micro-scale or nano-scale surface element, respectively, is defined as its extension in the direction of the length of the structured surface. Likewise, the width of a specific micro-scale or nano-scale surface element, respectively, is defined as its extension in the direction of the width of the structured surface.

The height of a protruding (or elevating) surface element is defined by its respective extension as measured from the adjacent bottom surface on which the respective protruding surface element is arranged in the direction perpendicular to such bottom surface. Likewise, the depth of a surface element extending downwardly from an adjacent top exposed surface is defined by its respective downward extension as measured from the adjacent top surface from which the indentation extends, in the direction perpendicular to such top surface.

The distance between two adjacent surface elements is defined as the distance between two maxima or two relative maxima, respectively, between such surface elements in a direction within the structured surface. Structured surfaces having a regular sequence of surface elements in one or more given direction parallel to the surface can be characterized by one or more pitch lengths in such directions. In a certain direction parallel to the surface the term pitch length denotes the distance between corresponding points of two adjacent, regularly repetitive surface elements. This may be illustrated for a structured surfaces comprising an alternating sequence of channel- and rail-type surface elements surface elements which both macroscopically extend, essentially parallel to each other, in a first longitudinal direction and which each have a micro- and, optionally, nano-scale cross-section normal to said longitudinal direction). The pitch length of such structured surface normal to the longitudinal direction is the sum of the width of the channel-type surface element and the width of the rail-type surface element in such normal direction.

The micro-scale and/or nano-scale surface elements of the silicone containing layer, particularly of the silicone layer (SiL) or the coating layer (C1) of composite (S1C1), preferably have a structure width of 10 nm to 1,000 μm, preferably 25 nm to 400 μm, more preferably 50 nm to 250 μm, very preferably 100 nm to 100 μm. Furthermore, the micro-scale and/or nano-scale surface elements of the silicone containing layer, particularly of the silicone layer (SiL) or the coating layer (C1) of composite (S1C1), preferably have a structure height of 10 nm to 1,000 μm, preferably 25 nm to 400 μm, more preferably 50 nm to 300 μm, very preferably 100 nm to 200 μm or 1 μm to 200 μm.

The structure width and structure height of the respective surface elements are preferably determined by production of a cross section of the silicone containing layer and determination of the structure height and structure width of said cross section by means of an optical microscopy.

The silicone containing layer, preferably the silicone layer (SiL) and the composite (S1C1), comprises at least one micro- and/or nanostructured surface containing a plurality of micro-scale and/or nano-scale surface elements. Said surface preferably comprises a repeating and/or regularly arranged pattern or are completely randomized. The structure in each case may be a continuous structure such as a continuous groove structure or else a plurality of preferably repeating individual structures. The respective individual structures in this case may in turn be based preferably on a groove structure having more or less strongly pronounced protrusions defining the height of the structure. In accordance with the respective geometry of the ridges of a preferably repeating individual structure, a plan view may show a multiplicity of preferably repeating individual structures, each of them different. It is also possible for at least two patterns to be superimposed on one another. The protrusions of the individual structures may also have a curvature, i.e., a convex and/or concave structure. Thus, the micro-scale and/or nano-scale surface elements of the silicone containing layer, preferably the silicone layer (SiL) or the coating layer (C1) of composite (S1C1), are forming a regular or irregular pattern selected from serpentine patterns, sawtooth patterns, diamond-shape patterns, rhomboidal patterns, parallelogrammatical patterns, honeycomb patterns, circular patterns, punctiform patterns, star-shaped patterns, rope-shaped patterns, reticular patterns, polygonal patterns, such as triangular, tetragonal, rectangular, square, pentagonal, hexagonal, heptagonal and octagonal patterns, wire-shaped patterns, ellipsoidal patterns, oval and lattice-shape patterns, QR codes or combination of said patterns.

### Optional Step (2):

In optional step (2) of the inventive process, a composition (C2a) comprising at least one binder (B) and optionally at least one crosslinker (CL) is applied on at least a part of the at least one inner surface (SU) facing the mold cavity of the closable, three dimensional mold (MO) and flashing off said applied composition (C2a). The composition (C2a)—if applied—is therefore present on at least part of a surface of the mold parts which come in contact with the composition (C3a) applied into the mold in step (5) of the inventive process.

The composition (C2a) is preferably used as release and/or coating agent to facilitate demolding of the structured molded article in step (8) of the inventive process and/or to realize a coating of the molded article during the molding process. The coating of the molded article renders post-coating processes superfluous. Moreover, the incorporation of a release agent into the coating composition allows to avoid the use of external release agents which hamper the adhesion of coating layers to the article and therefore require additional cleaning steps before a coating layer can be applied. In order to facilitate demolding of the structured molded article without damage and/or coating of said article on all surfaces, said composition (C2a) is preferably applied on all surfaces of the mold parts facing the mold cavity. This preferably includes the inner surfaces (SU) of the mold parts comprising the structured silicone containing layer, preferably the silicone layer (SiL) and/or the composite (S1C1), since coating of said structured surfaces allows to obtain a structured molded article comprising a coating on the structured surface of said article. However, it is likewise possible to only coat specific areas of the inner surface or to only coat one of several inner surfaces of the mold parts with the coating composition (C2a).

### Binder (B):

As first mandatory component, the composition (C2a) comprises at least one binder (B). The use of this binder B leads to the development of a flexible and stable coating on the article without negatively influencing the demoldability of said article.

Surprisingly, the excellent demoldability achieved with the composition (C2a) is independent of the chemical nature of the binder (B). A further surprise was that, independently of the chemical nature of the binder (B), release agents can be incorporated into said composition (C2a) without negatively influencing the surface quality and flexibility of the obtained coating layer. Moreover, the resulting coatings can be adhesively bonded to another components and/or coated with basecoat and/or clearcoat materials, without costly and inconvenient aftertreatment steps. The composition (C2a) may therefore include any binder or binder combination commonly used in coating compositions.

Suitable binders (B) are, for example, (i) poly(meth)acrylates, more particularly hydroxy-functional and/or carboxylate-functional and/or amine-functional poly(meth)acrylates, (ii) polyurethanes, more particularly hydroxy-functional and/or carboxylate-functional and/or amine-functional polyurethanes, (iii) polyesters, more particularly polyester polyols, (iv) polyethers, more particularly polyether polyols, (v) copolymers of the stated polymers, and (vi) mixtures thereof.

Binders (B1) and/or (B2):

Particularly preferred binders are selected from hydroxy-functional poly(meth)acrylates (B1) and/or polyester polyols (B2). The use of this binders, preferably a mixture of binders (B1) and (B2), leads to coatings which have a high flexibility and also high resistance toward environmental influences. Moreover, irrespective of the nature of the material used for producing the structured article, said binder combination does not negatively interfere with the transfer of the surface structure of the silicone containing layer, preferably the silicone layer (SiL) and/or composite (S1C1), to the material used in step (5) of the inventive process.

The at least one hydroxy-functional poly(meth)acrylate (B1) preferably possesses a hydroxyl number of 65 to 100 mg KOH/g, more particularly of 75 to 90 mg KOH/g or of 80 to 85 mg KOH/g. The hydroxyl number in the context of the present invention may be determined according to EN ISO 4629-2:2016 and is based in each case on the solids content. The hydroxyl functionality of said poly(meth)acrylate binder (B1) is preferably 5 to 15, more preferably 8 to 12. The poly(meth)acrylate binder (B1) can also comprise acid functional groups and might have an acid number between 6 to 14 mg KOH/g (as determined according to DIN EN ISO 2114:2002-06). Said hydroxy-functional poly(meth)acrylate preferably comprise a number average molecular weight Mₙ of 4,000 to 10,000 g/mol, more particularly 6,000 to 7,500 g/mol (determined by GPC using PMMA standards according to DIN 55672-1:2016-03).

The hydroxy-functional poly(meth)acrylate (B1) may be obtained by means of the polymerization reactions in the presence of initiators, like peroxides, such as di-tert-butyl peroxide, using the following monomers:

(a1) at least one hydroxy-functional (meth)acrylic ester, more particularly (meth)acrylic ester of the formula HC═CRₓ—COO—R_{y}—OH, in which Rₓ is H or CH₃ and R_{y} is an alkylene radical having 2 to 6, preferably 2 or 3 carbon atoms,
(a2) at least one carboxy-functional ethylenically unsaturated monomer, more particularly (meth)acrylic acid, and
(a3) at least one hydroxyl-free and carboxyl-free ester of (meth)acrylic acid and/or at least one hydroxyl-free and carboxyl-free vinyl monomer, more particularly styrene.

The polyester polyol (B2) preferably possesses a hydroxyl number of 100 to 200 mg KOH/g solids, more preferably of 120 to 160 mg KOH/g solids. The hydroxyl functionality of said polyester polyol (B2) is preferably 2.2 to 4, more preferably 2.7 to 3.6. Preferably, the acid number of the polyester polyol is rather low and generally lies in the range of 0.2 to 2 mg KOH/g solids. The number average molecular weight Mₙ is preferably 1,000 to 1,600 g/mol and can be determined as previously described for binder (B1). Particularly preferred polyester polyols (B2) are branched polyester polyols. Said polyester polyols can be prepared by reacting suitable polyols with diacids or the respective anhydrides of the diacids using methods well known to the person skilled in the art.

### Binder B3:

A further, particularly preferred binder is selected from polyurethane resins (B3). Polyurethanes (PU) generally consist a soft phase of comparatively high molecular weight polyhydroxy compounds and a urethane hard phase formed from low molecular weight chain extenders and di- or polyisocyanates. To increase the hardness of the polyurethanes, the amount of chain extenders can be increased

Polyurethane resins used as binder (B3) can be prepared by reaction of

(a1) isocyanates, preferably diisocyanates, with
(a2) isocyanate-reactive compounds, typically having a molecular weight (M_{w}) in the range from 500 to 10 000 g/mol and
(a3) chain extenders having a molecular weight in the range from 50 to 499 g/mol, if appropriate in the presence of
(a4) catalysts and/or
(a5) customary additive materials.

Suitable molar ratios of component (a2) to total chain extenders (a3) are in the range from 10:1 to 1:10, and in particular in the range from 1:1 to 1:4.

With particular preference, a mixture of at least one soft polyurethane comprising a shore hardness of below 60 (B3a) and at least on hard polyurethane comprising a shore hardness of more than 60 to 90 (B3b) is used as binder (B3). The shore hardness can be determined according to DIN 53505:2000-08 after 3 seconds. The hard polyurethane can be prepared as previously described by using 1,4-butanediol, 1,6-hexanediol and neopentyl glycol, either mixed with each other or mixed with polyethylene glycol as component (a2). The soft and hard polyurethanes are preferably used in the form of particles having an average particle diameter D50 of 120 to 150 nm (determined by DLS). With particular preference, said polyurethanes (B3a) and (B3b) are used as an aqueous dispersion preferably having a solids content of 25 to 45% by weight and comprising 10 to 30% wt of soft polyurethane (B3a) and 0 to 20% by weight of hard polyurethane (B3b). Suitable dispersions of mixtures of soft and hard polyurethanes are, for example, described in US 2010/0330356 A1.

A further, particularly preferred polyurethane binder (B3) is a mixture of at least three, preferably exactly three, different polyurethane resins (B3c), (B3d) and (B3e), each polyurethane resin having a gel fraction of at least 50% by weight, a glass transition temperature of less than −20° C. and a melting transition temperature of less than 100° C.

The polyurethane resin (B3c) preferably has a gel fraction of 55 to 80% by weight, a glass transition temperature of −90 to −40° C. and a melting transition temperature of −15 to less than 80° C. Said polyurethane (B3a) preferably comprises only a minor amount of functional groups which are able to enter into crosslinking reactions with the at least one crosslinker (CL) described below. Said minor amounts can be achieved by selecting a ratio of the total molar amount of isocyanate groups to the total molar amount of functional groups which are able to enter into crosslinking reactions with isocyanate groups, more particularly of hydroxyl groups and amino groups of exactly 1.0. The polyurethane resin (B3c) is preferably comprising at least one anionic group to facilitate dispersion of said polyurethane in water. The volume average particle size of the crosslinked polyurethane particles (B3c) is preferably 1 to 100 micrometer (measured according to DLS).

The polyurethane resins (B3d) and (B3e) preferably each have a gel fraction of 90 to 100% by weight, a glass transition temperature of −80 to −30° C. and do not possess a melting transition temperature. The volume average particle size of the crosslinked polyurethane particles (B3d) and (B3e) is preferably from 40 to 300 nm (measured by DLS). Preferably, the polyurethane resins (B3d) and (B3e) each have a hydroxyl and amine number of less than 20 and therefore only possess a minor amount of functional groups capable to react with the crosslinker (CL). Said polyurethane resins preferably comprise at least one ionic group to facilitate their dispersion in water. Suitable polyurethane resins (B3c) to (B3e) and dispersions containing said polyurethane resins are, for example, described in WO 2018/073034 A1.

The at least one binder (B) is present preferably in a total amount (solids content) of 15 to 55 wt %, more preferably of 25 to 40 wt %, more particularly 25 to 35 wt %, based in each case on the total weight of the composition (C2a). If the binder is a dispersion or solution in a solvent, the above-recited total quantities are calculated using the solids content of the binder in each case. If the binder (B) comprises a mixture of different polymers, the above-mentioned total quantities refer to sum of the different polymers. The use of the at least one binder (B) in the above-recited quantity ranges ensures the development of a flexible and stable coating on the structured article, but without adversely affecting the demoldability of the article.

### Crosslinker (CL):

The coating composition (C2a) can further comprises at least one crosslinker (CL). The at least one crosslinker (CL) is preferably used in combination with the above-described preferred binders B1, B2 and B3a to B3d.

If the crosslinker (CL) is present, said crosslinker (CL) is preferably selected from the groups consisting of amino resins, polyisocyanates, blocked polyisocyanates, polycarbodiimides, photoinitiators, and mixtures thereof.

Particular preference is given to using polyisocyanates as crosslinker (CL). The use of polyisocyanates has been found appropriate especially when the above mentioned particularly preferred binders B1 to B3d are used as binder (B) in the composition (C2a).

In this context it is particularly preferred if the polyisocyanate possesses an NCO group functionality of greater than 2.4 to 5, preferably 2.6 to 4, more preferably 2.8 to 3.6.

Employed with particular preference in the context of the present invention are polyisocyanates which comprise at least one isocyanurate ring or at least one iminooxadiazinedione ring. The polyisocyanate preferably comprises oligomers, preferably trimers or tetramers, of diisocyanates. With particular preference it comprises iminooxadiazinediones, isocyanurates, allophanates and/or biurets of diisocyanates. With particular preference the polyisocyanate comprises aliphatic and/or cycloaliphatic, very preferably aliphatic, polyisocyanates. Serving as a diisocyanate basis for the aforementioned oligomers, more particularly the aforementioned trimers or tetramers, is very preferably hexamethylene diisocyanate and/or isophorone diisocyanate, and especially preferably just hexamethylene diisocyanate.

The hardness, flexibility, and elasticity of the resulting cured coating layer obtained from the composition (C2a) can be influenced by the use and the type of crosslinker (CL). For example, use of polyisocyanates containing iminooxadiazinedione structures, leads to coatings of particular hardness, while hard but more flexible coating layers are obtained when using polyisocyanates containing isocyanurate structures. Since the structured molded article is preferably a flexible article, the use of polyisocyanates containing isocyanurate structures is preferred in order to prevent delamination of the coating layer (C2) during bending of the structured article.

The composition (C2a) preferably comprises the at least one crosslinker (CL) in a total amount of 10 wt % to 40 wt %, preferably of 10 to 30 wt %, more particularly of 15 to 25 wt %, based in each case on the total weight of the composition (C2a).

It is preferred, furthermore, if the composition (C2a) comprises a particular molar ratio of the functional groups of the crosslinker (CL) to the groups of binder (B) that are reactive toward the crosslinker (CL). This ensures that crosslinking of the composition (C2a) is sufficient. It is therefore advantageous if the molar ratio of the functional groups of the crosslinker (CL), especially of the NCO groups, to the sum of the functional groups of the at least one binder (B), especially hydroxyl groups or anionic groups, is 0.4:1 to 1:1, preferably 0.65:1 to 0.85:1, more particularly 0.7:1 to 0.8:1.

### Further Ingredients of Composition (C2a):

Apart from the binder (B) and optionally the crosslinker (CL) previously listed, the composition (C2a) can comprise further ingredients.

### Pigments:

Suitable further ingredients are organic or inorganic color pigments. Organic or inorganic color pigments are preferably used if the coating layer (C2) produced from the composition (C2a) should be colored or produce a matting effect. Organic or inorganic color pigments that can be used in such coating formulations are, for example white pigments such as titanium dioxide; black pigments such as carbon black, iron manganese black or spinel black; chromatic pigments such as ultramarine green, ultramarine blue or manganese blue, ultramarine violet or manganese violet, red iron oxide, molybdate red or ultramarine red; brown iron oxide, mixed brown, phases of spinel and corundum; or yellow iron oxide or bismuth vanadate; monoazo pigments, diazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments or aniline black, platelet-shaped metallic effect pigments such as platelet-shaped aluminum pigments, gold bronzes, oxidized bronzes and/or iron oxide aluminum pigments, pearlescent pigments and/or metal oxide-mica pigments, and/or other effect pigments such as platelet-shaped graphite, platelet-shaped iron oxide, multilayer effect pigments composed of PVD films, and/or liquid crystal polymer pigments.

In order to improve stable dispersion of the pigment in the composition (C2a), the pigments are preferably predispersed in a binder. Said binder can be the same or can be different from the aforestated binder (B). Suitable binders for predispersion of the pigment(s) are anionically stabilized polyurethane polymers having an acid number of 10 to 30 mg KOH/g solids and which are described, for example, in DE 199 24 457 A1.

The at least one pigment is preferably present in a total amount of 0.01 to 30% by weight, based on the total weight of the composition (C2a).

### Silicones:

The composition (C2a) may further comprise at least one silicone compound selected from the group of polyether-modified alkylpolysiloxanes, hydroxy-modified alkylpolysiloxanes, siloxanes comprising at least on carboxylic acid and/or amino group, polyalkylsiloxanes and mixtures thereof.

Suitable polyether-modified alkylpolysiloxane preferably comprises at least one structural unit (R⁴)₂(OR³)SiO_{1/2} and at least one structural unit (R⁴)₂SiO_{2/2}, where R³ is an ethylene oxide, propylene oxide, and butylene oxide group, more particularly a mixture of ethylene oxide and propylene oxide and butylene oxide groups, and R⁴ is a C₁-C₁₀ alkyl group, more particularly a methyl group. The molar ratio of siloxane groups to ethylene oxide to propylene oxide to butylene oxide groups is preferably 6:21:15:1 to 67:22:16:1. Moreover, the molar ratio of the structural unit (R⁴)₂(OR³)SiO_{1/2} to the structural unit (R⁴)₂SiO_{2/2} is preferably 1:10 to 1:15, more particularly of 1:10 to 1:13. R³ and R⁴ here have the definitions recited above. The polyether-modified alkylpolysiloxane is favorable present in a total amount of wt % or 0.1 to 6 wt %, preferably 0.5 to 4 wt %, more particularly 0.8 to 3 wt %, based in each case on the total weight of composition (C2a). The use of such polyether-modified alkylpolysiloxanes reduces the soiling of molded articles but slightly decreases the demolding of the molded article from the mold. Thus, if soiling of the molded article is not a problem, compositions (C2a) preferably do not comprise a polyether-modified alkylpolysiloxane.

Suitable hydroxy-functional polysiloxanes preferably possess the general formula (II)

R⁵—Si(R⁶)₂[O—Si(R⁶)(R⁷)]ₐ—[O—Si(R⁶)₂]_{b}—O—Si(R⁶)₂—R⁵ (II),

in which
R⁵ is a methyl group or a (HO—CH₂)₂—C(CH₂—CH₃)—CH₂—O—(CH₂)₃—* radical, preferably a (HO—CH₂)₂—C(CH₂—CH₃)—CH₂—O—(CH₂)₃—* radical,
R⁶ is a methyl group or a (HO—CH₂)₂—C(CH₂—CH₃)—CH₂—O—(CH₂)₃—* radical, preferably a methyl group,
R⁷ is a methyl group,
a is 0 or 1 to 10, preferably 0, and
b is 3 to 30, preferably 7 to 14.

The (HO—CH₂)₂—C(CH₂—CH₃)—CH₂—O—(CH₂)₃—* radical here is bonded via the * symbol to the respective silicone atom. Preferably, the hydroxy-functional polysiloxanes of general formula (II) is present in a total amount of 0.1 to 5 wt %, preferably 0.5 to 4 wt %, more particularly 0.8 to 2.5 wt %, based in each case on the total weight of the composition (C2a). The use of such hydroxy-functional polysiloxanes increases the demoldability without negatively affecting the adhesion of the cured composition (C2) to the molded structured article.

Suitable siloxanes comprising at least one carboxylic acid group and/or at least one amino group, preferably comprise on average 1 to 4 carboxylic acid and/or amino or aminoalkylamino groups. Said at least one functional group can be attached to the silicone atom directly or via a spacer at the terminal or non-terminal silicone atoms. Suitable spacers are selected from arylene, unsubstituted or substituted with one to four C₁-C₄-alkyl groups, alkylene and cycloalkylene such as for example 1,4-cyclohexylene. Preferred spacers are phenylene, in particular para-phenylene, also tolylene, in particular para-tolylene, and C₂-C₁₈-alkylene such as for example ethylene (CH₂CH₂), also —(CH₂)₃—, —(CH₂)₄—, —(CH₂)₅—, —(CH₂)₆—, —(CH₂)₈—, —(CH₂)₁₀—, —(CH₂)₁₂—, —(CH₂)₁₄—, —(CH₂)₁₆—, and —(CH₂)₁₈—. The amino group can include NH(isoC₃H₇) groups, NH(n-C₄H₉) groups, NH(cyclo-C₆Hᵢᵢ) groups and NH(n-C₄H₉) groups or aminoalkylamino groups such as for example —NH—CH₂—CH₂—NH groups, —NH—CH₂—CH₂—CH₂—NH₂ groups, —NH—CH—CH NH(C₂H₅) groups, NH—CH₂—CH₂—CH₂—NH(C₂H₅) groups, NH—CH₂—CH₂—NH(CH₃) groups, —NH—CH₂—CH₂—CH₂—NH(CH₃) groups, in particular NH₂ groups. Said siloxanes further comprise non-functional siloxane groups, in particular di-C₁C₁₀-alkyl-SiO₂ groups or phenyl-C₁-C₁₀-alkyl-SiO₂ groups, in particular dimethyl-SiO₂ groups, and if appropriate one or more Si(C₃H₂)—OH groups or Si(CH₃)₃ groups. Preferably, the number average molecular weight Mₙ of said silicone compound is in the range from 500 to 10 000 g/mol, preferably up to 5000 g/mol.

Suitable polydialyklsiloxanes are, for example, polydi-C₁-C₄-alkylsiloxanes. The C₄-alkyl in the polydialkylsiloxane may be different or preferably the same and selected from methyl, ethyl, n-propyl, isopropyl. n-butyl, isobutyl, sec-butyl and tert-butyl, of which unbranched C₁-C₄-alkyl is preferred and methyl is particularly preferred. Said siloxanes preferably comprise unbranched polysiloxanes having Si—O—Si chains or such polysiloxanes as have up to 3 and preferably not more than one branching per molecule.

Fatty Acid and/or Fatty Alcohol Compound:

The composition (C2a) may further comprise at least one fatty acid and/or fatty alcohol compound of general formula (III):

R⁸—(C═O)ᵣ—O-(AO)ₛ—R⁹ (III)

where
R⁸ is a saturated or unsaturated, aliphatic hydrocarbon radical having 6 to 30 carbon atoms, preferably 8 to 26, more preferably 10 to 24, and very preferably 12 to 22 carbon atoms,
R⁹ is H or a saturated aliphatic hydrocarbon radical having 1 to 10 carbon atoms, preferably H,
AO stands for one or more alkylene oxide radicals selected from the group consisting of ethylene oxide, propylene oxide and butylene oxide,
r is 0 or 1, and
s is 0 to 30, preferably 1 to 25 or 2 to 25, more preferably 4 to 22 or 6 to 20, and very preferably 0 or 8 to 18.

The radicals AO may be identical or different and within the s radicals may have a random, blockwise or gradientlike arrangement. Where two or more different kinds of AO are included, it is preferred if the fraction of ethylene oxide is more than 50 mol %, more preferably at least 70 mol %, and very preferably at least 90 mol %, based on the total molar amount of the radicals AO. In the aforementioned cases the radicals different from ethylene oxide are preferably propylene oxide radicals.

Where r=0 and s>0, the species of the formula (III) are alkoxylated fatty alcohols, whereas the species of formula (III) are alkoxylated fatty acids if r=1 and s>0. If s=0, species of formula (III) are either fatty alcohols or fatty acids. It is preferred if mixtures of species of formula (III), in which s is 0 for at least one species and s is >0, preferably 8 to 18 for at least a further species are used. If s is >0, it is preferred if the ethylene oxide fraction in the total molar amount of the radicals AO is at least 70 mol %.

A particularly preferred mixture of compounds of general formula (III) is composed of general formula (III) having an number average molecular weight of about 650 g/mol and wherein R⁸=mixture of saturated and unsaturated hydrocarbon radicals having 12 to 22 carbon atoms, r=0, AO=mixture of primarily ethylene oxide units and a few propylene oxide units, and R⁹═H and of general formula (III) wherein R⁸=unsaturated hydrocarbon radical having 21 carbon atoms, s=0, and R⁹═H.

The total weight of the compound of the general formula (III) is preferably 0.1 to 10 wt %, more preferably 0.5 to 5 wt %, more particularly 1.5 to 4 wt % based in each case on the total weight of the composition (C2a).

The use of said compounds of general formula (III) facilitates the demolding of the molded article without negatively influencing the adhesion and further properties of the coating layer formed by the cured coating composition (C2a).

### Crosslinking Catalysts:

The composition (C2a) may further comprise at last one crosslinking catalyst. The crosslinking catalyst serves primarily to catalyze the reaction between the functional groups of the crosslinker (CL) and the reactive groups of the at least one binder (B). The use of a crosslinking catalyst is particularly preferred if binders B1 and B2 in combination with an isocyanate crosslinker previously described are contained in the composition (C2a).

The crosslinking catalyst is preferably selected from the group of the bismuth carboxylates. Particularly preferred bismuth carboxylates possess the general formula (IV)

Bi[OOC(CₙH₂ₙ₊₁)]₃ (IV)

where n=5 to 15, preferably n=7 to 13, more particularly n=9 to 11.

The carboxylate radicals are preferably branched, and very preferably they have a tertiary or quaternary, preferably quaternary, carbon atom in the alpha-position to the carbon atom of the carboxylate group. Among the bismuth carboxylates, bismuth trineodecanoate in particular has emerged as being especially suitable.

The bismuth carboxylates are preferably used in stabilized form in combination with the parent carboxylic acid of the carboxylate, HOOC(CₙH₂ₙ₊₁), in which n possesses the definition indicated above. The free carboxylic acid here should formally not be regarded, for the purposes of this invention, as a constituent of the crosslinking catalyst, even if it may have not only the stabilizer effect but also, optionally, may serve as a catalysis promoter; instead, it is included among the further additives as described below.

The composition (C2a) preferably comprises the at least one crosslinking catalyst in a total amount of 0.01 wt % to 3.5 wt %, preferably of 0.1 to 2 wt %, more particularly of 0.4 to 1.5 wt %, based in each case on the total weight of the composition (C2a).

### Additives:

The composition (C2a) can comprise further additives, customarily used in coating compositions, for example antilusterants, light stabilizers, antistatic agents, antisoiling agents, anticreak agents, dispersants, flow control agents, UV absorbers, thickening agents, microballons and mixtures thereof. If present, the additives are contained in amounts which do not hinder the demolding of the molded article or interfere with the adhesion and further mechanical and optical properties of the cured composition (C2a). Normally, said additives are used in a total amount of up to 10% wt., based on the total weight of the composition (C2a).

The composition (C2a) used in optional step (2) of the inventive process may be a solvent-based composition or an aqueous composition. In the case of a solvent-based composition, organic solvents are included as a principal constituent. Organic solvents constitute volatile components of the composition and undergo complete or partial vaporization on drying or flashing, respectively. Suitable organic solvents are, for example, ketones such as acetone, methyl ethyl ketone, cyclohexanone, methyl isobutyl ketone, methyl isoamyl ketone or diisobutyl ketone; esters such as ethyl acetate, n-butyl acetate, ethylene glycol diacetate, butyrolactone, diethyl carbonate, propylene carbonate, ethylene carbonate, 2-methoxypropyl acetate (MPA), and ethyl ethoxypropionate; amides such as N, N-dimethylformamide, N, N-dimethylacetamide, N-methylpyrrolidone, and N-ethylpyrrolidone; methylal, butylal, 1,3-dioxolane, glycerol formal. Especially preferred organic solvents are n-butyl acetate and 1-methoxypropyl acetate.

The principal constituent of aqueous compositions is water and organic solvents are preferably present in an amount of less than 1% wt, based on the composition (C2a).

The at least one solvent, preferably organic solvent and/or water, is preferably present in a total amount of 40 to 70 wt %, more preferably 45 to 65 wt %, and very preferably 50 to 60 wt %, especially 52 to 58 wt %, based in each case on the total weight of the Composition (C2a).

The composition (C2a) preferably possesses a solids content of 30 to 60 wt %, more preferably of 35 to 55 wt %, very preferably of 40 to 50 wt %, more particularly of 42 to 48 wt %, based on the total weight of the composition. The solids content was determined according to ASTM D2369 (2015) at 110° C. for 60 min on a 2 gram sample of the composition (C2a).

Depending on the particular binders (B) and optional crosslinkers (CL) present in the composition (C2a), said composition is configured as a one-component system or is obtainable by mixing two (two-component system) or more (multicomponent system) components. In thermochemically curable one-component systems, the components to be crosslinked, in other words binder and crosslinking agent, are present alongside one another, in other words in one component. A condition for this is that the components to be crosslinked react with one another effectively only at relatively high temperatures, of more than 100° C., for example, so as to prevent premature at least proportional thermochemical curing. Such a combination may be exemplified by hydroxy-functional polyesters and/or polyurethanes with melamine resins and/or blocked polyisocyanates as crosslinking agents.

In thermochemically curable two-component or multicomponent systems, the components to be crosslinked, in other words binders and the crosslinking agents, are present separately from one another in at least two components, which are not combined until shortly before the application. This form is selected when the components to be crosslinked react with one another effectively even at ambient temperatures or slightly elevated temperatures of, for example, 40 to 90° C. Such a combination may be exemplified by hydroxy-functional polyesters and/or polyurethanes and/or poly(meth)acrylates with free polyisocyanates as crosslinking agents. Particularly preferred compositions (C2a) are two-component compositions which have to be mixed prior to application onto the inner surface of the mold and which preferably comprise the binder (B) and the crosslinker (CL) in separate containers. In case the composition (C2a) is obtainable by mixing two or more components, the weight ratio of the binder-containing component to the crosslinker-containing component is preferably 100:10 to 100:100, more preferably from 100:20 to 100:80, more particularly from 100:50 to 100:70. The use of the above-described mixing ratios ensures sufficient crosslinking of the composition (C2a) resulting in a high adhesion to the molded article as well as an excellent demoldability.

Mixing may take place manually, with the appropriate amount of a first component being introduced into a vessel, admixed with the corresponding quantity of the second component. However, mixing of the two or more components can also be performed automatically by means of an automatic mixing system. Such an automatic mixing system can comprise a mixing unit, more particularly a static mixer, and also at least two devices for supplying the binder containing first component and the crosslinker containing second component, more particularly gear pumps and/or pressure valves. The static mixer may be a commercially available helical mixer, which is installed into the material supply line about 50 to 100 cm ahead of the atomizer. Preferably 12 to 18 mixing elements (for each element 1 cm in length, diameter 6 to 8 mm) are used in order to obtain sufficient mixing of the two components. Depending on the mixing energy, the pot life (doubling of the viscosity; determined according to DIN 53211) of the composition (C2a) when the above-described 12 to 18 mixing elements are used is 10 to 20 minutes. In order to prevent clogging of the material supply line, it is preferred if the mixing unit is programmed so that not only the helical mixer but also the downstream hose line and the atomizer are flushed with the first component every 7 to 17 minutes. Where the composition (C2a) is applied by means of robots, this flushing operation takes place when the robot head is in a pre-defined position of rest. Depending on the length of the hose line, about 50 to 200 ml are discarded into a catch vessel. A preferred alternative to this procedure is the semicontinuous conveying of mixed release agent composition. If composition (C2a) is forced out regularly (every 7 to 17 minutes, likewise into a catch vessel), it is possible to reduce the quantity of discard material to a minimum (about 10 to 50 ml). Furthermore, provision may be made for the hose line from the mixer to the atomizer, and also the atomizer, to be flushed. This flushing operation is preferred in particular after prolonged downtime of the system or at the end of a shift, in order thus to ensure a long lifetime of the equipment and continuous quality of the composition (C2a).

Also possible in principle is the utilization of a three-component mixing system. This may simplify the stable storage of systems which have already been catalyzed, without giving rise to greater cost and complexity in terms of process engineering. Both in the case of manual mixing and in the case of the supply of the components for automatic mixing, the two components preferably each possess temperatures of 15 to 70° C., more preferably 15 to 40° C., more particularly 20 to 30° C.

The composition (C2a) can be applied on the at least a part of at least one inner surface of the mold either manually by using commonly known application gear for liquid coating compositions, for example spray guns, or by means of an application robot. In terms of economy, the use of application robots is preferred. The robots are programmed for the geometry of the mold parts and apply the composition (C2a) pneumatically and autonomously to the inner surface of the mold parts.

Where the composition (C2a) is applied by means of application robots, it is preferred in accordance with the invention if, during the application of the composition with deployment of application robots, nozzles are used that have a diameter of 0.05 to 1.5 mm, preferably of 0.08 to 1 mm, more particularly of 0.1 to 0.8 mm. The use of nozzles having the afore-described diameters ensures that the inner surface of the mold parts of the mold are wetted with a sufficient amount of composition (C2a), while at the same time preventing the application of too large a quantity of said composition.

A particularly preferred composition (C2a) is a solvent-based two-component composition (hereinafter denoted as (C2a-1)) comprising:
at least one binder (B)
at least one crosslinker (CL),
at least one compound of general formula R⁸—(C═O)ᵣ—O-(AO)ₛ—R⁹ (III), wherein R⁸ is a saturated or unsaturated hydrocarbon radical having 6 to 30 carbon atoms, R⁹ is hydrogen, AO stands for one or more alkylene oxide radicals selected from the group consisting of ethylene oxide, propylene oxide and butylene oxide, r is 0 or 1 and s is 0 to 30,
optionally least one polyether-modified alkylpolysiloxane
at least one hydroxy-functional polysiloxanes of general formula R⁵—Si(R⁶)₂—[O—Si(R⁶)(R⁷)]ₐ—[O—Si(R⁶)₂]_{b}—O—Si(R⁶)₂—R⁵, wherein R⁵ is a (HO—CH₂)₂—C(CH₂—CH₃)—CH₂—O—(CH₂)₃—* radical, R⁶ is a methyl group, R⁷ is a methyl group, a is 0 and b is 7 to 14, and
optionally at least one pigment and/or at least one UV absorber.

In a specific embodiment of composition (C2a-1), the at least one binder (B) in composition (C2a-1) is selected from hydroxy-functional poly(meth)acrylates (B1), preferably having a hydroxyl number of 75 to 90 mg KOH/g solids, and/or polyester polyols (B2), preferably having a hydroxyl number of 110 to 180 mg KOH/g solids. The weight ratio of binder (B1) to binder (B2) is 1:1 to 1:1.7. The at least one crosslinker is a polyisocyanate having a NCO group functionality of 2.6 to 4 and contains at least one isocyanurate ring. The at least one compound of general formula (III) is a mixture of at least one compound of general formula R⁸—(C═O)ᵣ—O-(AO)ₛ—R⁹ (IIIa), wherein R⁸ is mixture of saturated and unsaturated hydrocarbon radicals having 12 to 22 carbon atoms, r=0, AO=mixture of primarily ethylene oxide units and a few propylene oxide units, and R⁹═H and at least one compound of general formula R⁸—(C═O)ᵣ—O-(AO)ₛ—R⁹ (IIIb) wherein R⁸=unsaturated hydrocarbon radical having 21 carbon atoms, s=0, and R⁹═H. Said composition (C2a-1) further comprises at least one crosslinking catalyst of general formula Bi[OOC(CₙH₂ₙ₊₁)]₃ where n=9 to 11.

A further particularly preferred composition (C2a) is an aqueous two-component composition (hereinafter denoted as (C2a-2)) comprising:
at least one soft polyurethane (PU1) having a shore hardness of less than 60 (B3a) and/or at least one hard polyurethane (PU2) having a shore hardness of more than 60 to 90 (B3b) as binder (B),
at least one crosslinker (CL),
at least one polydimethylsiloxane
at least one siloxane comprising on average 1 to 4 aminoalkylamino groups, and
optionally at least one pigment and/or thickening agent and/or microballon.

In a specific embodiment of composition (C2a-2), the binder (B) comprises a mixture of the soft polyurethane (PU1) and the hard polyurethane (PU2). The weight ratio of polyurethane (PU1) to (PU2) is 2:1 to 1:2. The at least one crosslinker is selected from polyisocyanates having a NCO group functionality of 2.8 to 3.6 and at least one isocyanurate ring.

Another particularly preferred composition (C2a) is an aqueous two-component composition (hereinafter denoted as (C2a-3)) comprising:
at least a first aqueous dispersion comprising a polyurethane resin (B3c) having a gel fraction of at least 50 wt %, a glass transition temperature of less than −20° C. and a melting transition at a temperature of less than 100° C.,
at least a second aqueous dispersion comprising a polyurethane resin having a gel fraction of at least 50 wt % and being present in the form of dispersed particles with a volume average particle size of 20 to 500 nm,
at least one hydrophilically modified polyisocyanate having a NCO content of 8 to 18%,
optionally at least one filler and/or at least one UV absorber.

In a specific embodiment of composition (C2a-3), the polyurethane resin (B3c) has a gel fraction of 61 wt %, a glass transition temperature of −47° C., a melting transition at T=50° C. and a volume average particle size of more than 1 micrometer. The second aqueous dispersion of composition (C2a-3) comprises a mixture of a first polyurethane resin (B3d) having a gel fraction of 91 wt % and a glass transition temperature of −48° C. and a second polyurethane resin (B3e) having a gel fraction of 95 wt % and a glass transition temperature of −60° C. The at least one crosslinker is a polyoxyethylene and/or polyoxypropylene modified polyisocyanate comprising at least one isocyanurate ring. The at least one filler is selected from silicates.

After application of the composition (C2a) to at least a part of the inner surface (SU) of the mold facing the mold cavity, the applied composition (C2a) is flashed off. As already observed above, however, there is no substantial crosslinking or curing of this composition during the flash off. In accordance with the invention, the flashing of the composition (C2a) in process step (2) takes place preferably fora period of 20 seconds to 20 minutes, more preferably of 1 to 20 minutes, more preferably 2 to 10 minutes, very preferably 4 to 6 minutes.

To accelerate the flashing of the composition (C2a), it is advantageous if the mold, preferably the surface of the mold parts coming in contact with composition (C2a), is heated. The flash off is therefore preferably performed at a temperature of 20 to 190° C., more preferably 30 to 150° C., very preferably from 40 to 140° C., more particularly 50 to 120° C. such as 50 to 70° C. or 120 to 130° C. All afore-stated temperatures relate to the surface temperature of the mold parts being in contact with composition (C2a). The mold can be heated by supplying heat or by irradiation, for example IR radiation. Preferably the mold is heated by means of IR radiation.

The aforesaid temperatures result in rapid evaporation of the solvents present in the composition (C2a), and also in formation of a film on the surface of mold facing the mold cavity. Solvent-based compositions (C2a) are preferably flashed off at temperatures of 50 to 70° C. while aqueous compositions (C2a) are flashed off at higher temperatures of 120 to 130° C. At these temperatures, however, there is no sufficient crosslinking or curing of the composition (C2a). In this way it is ensured that there is no deterioration in the adhesion between the coating layer produced by composition (C2a) and the compositions (C3a, C4a) and materials (M1) used in the further process steps since the high adhesion of the coating (C2) generated by the composition (C2a) on the surface of the structured article is achieved through simultaneous crosslinking of the composition (C2a) and of the composition (C3a) that forms the structured article.

The composition (C2a) is applied in step (2) preferably in a quantity such that a defined dry film thickness is obtained after the flash off. It is therefore preferred if the dry film thickness of the flashed composition (C2a) in process step (2) is 20 to 120 μm, more particularly 25 to 100 μm. This ensures that the coating produced from composition (C2a) on the structured article guarantees effective protection against mechanical and environmental influences.

### Optional Step (3):

In optional step (3) of the inventive process, a material (M1) is inserted into the mold. Material (M1) is preferably inserted in such a way into the mold that said material is not in contact with the inner surface(s) of the mold part(s) comprising the structured silicone containing layer, preferably the silicone layer (SiL) or composite (S1C1). The mold is afterwards heated to activate the inserted material (M1). After insertion of the material (M1), the mold can be closed prior to heating of the mold.

With particular preference, the material (M1) inserted in process step (3) is an outsole, more particularly an outsole made of thermoplastic polyurethane. Thermoplastic polyurethanes may be prepared by reaction of high molecular mass polyols, such as polyester polyols and polyether polyols, having a number-average molecular weight of 500 to 10 000 g/mol, with diisocyanates and also low molecular mass diols (Mₙ 50 to 499 g/mol). It is also possible, however, to use outsoles made of other materials such as vulcanized or unvulcanized rubber and also mixtures of rubber and plastics.

Especially when using thermoplastic materials (M1), it is advantageous if the mold, preferably the surface of the mold parts being in contact with material (M1), is heated in process step (3) in order to render the material (M1) deformable and in that way to adapt it to the inner cavity formed by the mold parts. It is therefore preferred if the mold is heated in process step (4) to a temperature of 20 to 100° C., more preferably 30 to 90° C., very preferably 40 to 80° C., more particularly 50 to 70° C. The mold can be heated as previously described in process step (2).

### Optional Step (4):

In optional process step (4), the mold is closed. Closing of the mold can be performed manually or automatically, for example hydraulically. The mold can comprise means to fix the mold parts in the closed state, for example attachments for clamping means. Closing of the mold is preferably performed if the composition (C3a) is injected into the closed mold in process step (5).

### Step (5):

In step (5) of the inventive method, a composition (C3a) is applied into the open or closed mold, optionally containing the material (M1) inserted in step (3). If the composition (C3a) is applied into the open mold in step (5), the mold is afterwards closed as previously described in connection with process step (4).

Composition (C3a) is a crosslinkable composition. Accordingly, either the composition must be self-crosslinking, or the composition must include corresponding crosslinking agents. With particular preference, the composition (C3a) applied in process step (5) is a polymer foam material, more particularly selected from polyurethane foam materials, polystyrene foam materials, polyester foam materials, butadiene styrene blockcopolymer foam materials and aminoplast foam materials, very preferably from polyurethane foam materials. Polymer foam materials are, in the context of the present invention, thermosets, thermoplastics, elastomers, or thermoelastics from which polymer foams can be produced by a foaming process. In terms of their chemical basis, possible polymer foam materials include for example, but not exclusively, polystyrenes, polyvinyl chlorides, polyurethanes, polyesters, polyethers, polyetheramides, or polyolefins such as polypropylene, polyethylene, and ethylene-vinyl acetate, and also copolymers of the polymers stated. The polymer foams produced from composition (C3a) can include, among others, elastomeric foams, more particularly flexible foams, but also thermoset foams, more particularly rigid foams, and also integral foams. The foams may be open-cell, closed-cell or mixed-cell foams.

The production of the polymer foam by the foaming process is achieved by curing (i.e. foaming) the applied foam material as described in connection with process step (6). Foaming processes are known, and will therefore be presented only briefly. A fundamental principle in each case is that blowing agents and/or gases in solution in the plastic or in a corresponding plastics melt, and formed in crosslinking reactions in the production of corresponding polymeric plastics, are released and so bring about the foaming of the hitherto comparatively dense polymeric plastics. For example, where a low-boiling hydrocarbon is employed as a blowing agent, it vaporizes at elevated temperatures and leads to foaming. Gases such as carbon dioxide or nitrogen as well can also be introduced into the polymer melt at high pressure and/or dissolved therein, as blowing agents. As a result of a later drop in pressure, the melts then foam during the escape of the blowing agent gas.

Particularly preferred polymer foam materials are polyurethane foam materials. These are customarily produced from one or more polyols and one or more polyisocyanates. The blowing agent added to the polyol component to form the foam is usually water, which reacts with part of the polyisocyanate to form carbon dioxide, the reaction therefore being accompanied by foaming. Soft to elastic foams, especially flexible foams, are obtained using long-chain polyols. If short-chain polyols are used, highly crosslinked structures are formed, leading generally to the formation of rigid foams.

The polyols used in producing the polyurethane foam materials preferably comprise polyester polyols, polyether polyols and/or polyester polyether polyols, and are accordingly selected preferably from the group of the aforesaid polyols.

It is also possible first to produce pellets of thermoplastic polymers, for example thermoplastic polyurethanes. These pellets already contain a blowing agent and can be foamed in the mold, with the pellets increasing their volume, fusing with one another, and ultimately forming an article consisting of fused expanded foam beads (also called thermoplastic bead foam). The expandable pellets may be formed, for example, by extrusion and subsequent pelletizing of the polymer strand exiting the extruder. Pelletization is accomplished, for example, via appropriate chopping devices, operating under pressure and temperature conditions such that no expansion occurs.

It is also possible to start from plastics pellets that have already been prefoamed when producing thermoplastic bead foams. These are pellets whose individual pellets or polymer beads, in comparison to pellets that have not been prefoamed, already exhibit substantially increased bead sizes with correspondingly reduced densities. The production of beads with controlled prefoaming can be realized by appropriate process control, as described in WO 2013/153190 A1, for example. Hence, on exiting the extruder, extruded polymer strands may be passed into a pelletizing chamber with a stream of liquid, the liquid being under specific pressure and having a specific temperature. Through adaptation of the operating parameters, it is possible to obtain specific expanded or preexpanded thermoplastic pellets, which can be converted into thermoplastic bead foam substrates by subsequent fusing and, optionally, further expansion with—in particular—steam.

Thermoplastic bead foams and corresponding thermoplastic, expandable and/or expanded pellets from which such bead foams may be produced are described in WO 2007/082838 A1, WO 2013/153190 A1 or else WO 2008/125250 A1, for example.

Fibers may be admixed to the polymer foam material. When such materials are foamed, the products are known as fiber-reinforced foams. Fibers are preferably used when producing rigid foams.

Application may take place by means of devices known in principle. With particular preference the composition (C3a) is applied automatically in process step (5). Application of composition (C3a) in process step (5) may be performed by injecting the composition (C3a) into the closed mold or by spraying the composition (C3a) into the preferably open mold.

The composition (C3a) can be applied in one step or in a plurality of steps into the mold. Application of composition (C3a) in a plurality of steps is preferably carried out when the mold comprises a plurality of mold cavities. In that case the composition (C3a) in a first stage is injected into the first mold cavity and in a second stage is injected into the second mold cavity. This technique is employed, for example, when the first mold cavity represents an outsole and the second mold cavity represents a self-contained sole frame.

### Step (6):

According to step (6) of the inventive process, the composition (C3a) and optionally the composition (C2a) are at least partially cured. At least partial curing of composition (C3a) represents the foaming process previously described in connection with process step (5). If the composition (C2a) is present, the at least partial crosslinking of said composition on the surface of the foam material formed in this step results in a high adhesion of the cured composition (C2a) to the foam produced from composition (C3a) and hence improves the mechanical and optical properties of the resultant coated and structured article.

The in order to achieve sufficient crosslinking and foaming, elevated temperatures are preferably used in process step (6). It is therefore advantageous if the composition (C3a) and optionally the composition (C2a) are at least partially cured in process step (6) at a temperature of 45 to 120° C., preferably 50 to 100° C., more particularly 52 to 95° C. for a period of 1 to 20 minutes, preferably after 3 to 15 minutes, more particularly after 4 to 10 minutes.

### Optional Step (7):

In optional step (7), a further composition (C4a) can be applied into the mold and at least partially cured. The composition (C4a) can be injected into the closed mold.

Alternatively, the mold can be opened after step (6) before composition (C4a) is applied. Afterwards, the mold is closed and composition (C4a) is cured.

The composition (C4a) applied in process step (7) is preferably different from the composition (C3a) and is selected from (i) polymer foam materials, more particularly selected from polyurethane foam materials, polystyrene foam materials, polyester foam materials, butadiene styrene blockcopolymer foam materials and aminoplast foam materials, very preferably from polyurethane foam materials, (ii) powder compositions and (iv) mixtures thereof.

This process step may be repeated as often as desired. Accordingly, it is also possible for further compositions (C5a, C6a), etc., to be applied, preferably likewise being different from one another. The compositions may differ, for example, in density, in color, or in the material used. In this way, multilayer structured articles can be produced, the properties of the article being adapted through the choice of the compositions used in steps (6) and (7). If step (7) is carried out, the mold parts are preferably moved before application of the composition (C4a) in such a way that a further cavity is formed in which the composition (C4a) can be applied. This may be done, for example, by moving the core plate or the mold part that closes the mold at the top.

The curing or crosslinking of the compositions applied in step (7) preferably takes place at a temperature of 45 to 120° C., preferably 50 to 100° C., more particularly 52 to 95° C. for a period of 1 to 20 minutes, preferably after 3 to 15 minutes, more particularly after 4 to 10 minutes.

### Step (8):

In process step (8) of the process of the invention, the mold is opened and the structured and optionally coated article is removed. Provision may be made in accordance with the invention for the position of at least one mold part of the mold to be altered, in particular hydraulically, before the mold is opened. The opening of the mold as well as the removal of the structured and optionally coated article can be performed manually or automatically. In order to facilitate removal of said article, one of the mold parts can be moved, preferably hydraulically.

### Optional Step (9):

Following removal of the structured and optionally coated article in step (8), said article can to be post-treated. The post-treatment in step (9) preferably comprises trimming and/or polishing and/or coating of the structured article. The article may, if desired, be coated directly—without an intermediate sanding procedure—with further coating materials such as, for example, with at least one basecoat composition and/or at least one clearcoat composition, to form at least one colored basecoat film and/or at least one clearcoat film, respectively. Prior to application of the at least one basecoat and/or clearcoat composition, the article obtained after step (8) is preferably not coated with a surfacer or primer layer. The applied basecoat and/or clearcoat composition can be cured either separately or jointly.

As basecoat and clearcoat compositions, all basecoat and clearcoat compositions commonly used to coat substrates can be used and which can be cured at temperatures that will not damage the structured article. Suitable basecoat and clearcoat compositions are, for example available from BASF Coatings GmbH. Clearcoat compositions which are particularly suitable are clearcoat materials of the EverGloss product line.

### Further Process Steps:

The inventive process may comprise further process steps in addition to the mandatory and optional process steps previously listed. For example, the structured silicone containing layer, preferably the silicone layer (SiL) and/or composite (S1C1), can be removed after step (8) or can be exchanged against a structured silicone containing layer, preferably silicone layer (SiL) and/or composite (S1C1), comprising the same or a different structure. Alternatively, a further structured silicone containing layer, preferably silicone layer (SiL) and/or composite (S1C1), can be attached to at least a part of the inner surface of the mold part not yet covered with a structured silicone containing layer, preferably silicone layer (SiL) and/or composite (S1C1).

Moreover, the mold cavity can be cleaned after step (8). Cleaning can be performed either manually or automatically by the use of sandblasting or organic solvents. This cleaning step ensures that the surface of the mold parts and the structured silicone containing layer, preferably silicone layer (SiL) and/or composite (S1C1), has no unwanted residues which reduce the demolding of the molded article and/or the structure transfer to the molded article.

The process of the invention results in three-dimensional molded articles having at least one structured and optionally coated surface. The process allows to transfer the structure of the mold to the article in a high molding accuracy. Additionally, the structured article can be simultaneously coated during the manufacturing process with a coating which as an excellent adhesion to the article and is highly elastic or flexible. Said coating also improves the demolding of the article from the mold, thus rendering the use of external release agents, which require costly and inconvenient removal before post-treatment, superfluous. Since the structuring of the mold ports is achieved by using structured inlays which can be produced at low costs and can be easily exchanged, the inventive process is highly flexible with respect to the structure transferred to the molded article. Additionally, said inlays can be easily removed and exchanged when they are worn out or soiled, thus avoiding labor-intensive cleaning of the molds or reshaping of the mold structures.

### Inventive Article:

After step (8) or optional step (9) of the inventive process, a molded article comprising at least one structured and optionally coated surface is obtained.

The structured molded article is preferably a shoe sole. Since coating of the structured article is possible during the production process, shoe soles made of polymer foam can be obtained which can be coated with coating layers having a high adhesion, a good optical quality, a high mechanical resistance and flexibility, good soil resistance and outstanding weathering stability.

With regard to further preferred embodiments of the inventive article, particularly in relation to the process used to prepare the article, the comments made above regarding the process of the invention are valid mutatis mutandis.

The invention is described in particular by the following embodiments:

Embodiment 1: process for preparing a molded article comprising at least one structured surface, said process comprising the following steps in the stated order:
(1) providing a closable, three dimensional mold (MO) having at least two mold parts which are movable relative to each other and which form a mold cavity, wherein at least one micro- and/or nanostructured silicone containing layer comprising a plurality of micro-scale and/or nano-scale surface elements is attached to at least a part of the inner surface (SU) facing the mold cavity of at least one of the mold parts;
(2) optionally applying a composition (C2a) comprising at least one binder (B) and optionally at least one crosslinker (CL) on at least a part of at least one inner surface (SU) facing the mold cavity of the closable, three dimensional mold (MO) and flashing off said applied composition (C2a);
(3) optionally inserting at least one material (M1) into the mold (MO), wherein the at least one material (M1) is preferably not in contact with the inner surface (SU) of the mold parts comprising the silicone containing layer, and heating the mold (MO);
(4) optionally closing the mold (MO);
(5) applying a composition (C3a) into the closed mold (MO) or applying a composition (C3a) into the open mold (MO) and closing said mold (MO);
(6) at least partially curing of the composition (C3a) and optionally of the composition (C2a);
(7) optionally applying at least one further composition (C4a) and at least partially curing of said composition (C4a);
(8) opening of the mold (MO) and removing the molded article comprising at least one structured and optionally coated surface;
(9) optionally post-treating of the article obtained after step (8).

Embodiment 2: process according to embodiment 1, wherein the process can be a manual process or an automatic process.

Embodiment 3: process according to embodiment 1 or 2, wherein the mold parts are selected from metallic mold parts, preferably steel, nickel or copper mold parts, very preferably steel mold parts, and/or from polymeric mold parts, preferably polyamide mold parts.

Embodiment 4: process according to any of the preceding embodiments, wherein the unstructured side of the silicone containing layer is attached on at least one inner surface (SU) of the at least one mold part, said mold part facing the mold cavity, and wherein said attached silicone containing layer is optionally fixed by means of pressure differences, vacuum, an adhesive layer, clamping or magnetic forces on said inner surface (SU1).

Embodiment 5: process according to any of the preceding embodiments, wherein the silicone containing layer is selected from
(i) at least one micro- and/or nanostructured silicone layer (SiL) containing a plurality of micro-scale and/or nano-scale surface elements and/or
(ii) at least one composite (S1C1) comprising a substrate (S1) and at least one micro- and/or nanostructured coating layer (C1) containing at least one silicone compound and a plurality of micro-scale and/or nano-scale surface elements.

Embodiment 6: process according to embodiment 5, wherein the micro- and/or nanostructured silicone layer (SiL) is obtained by
(i) providing a cured silicone layer, optionally on a carrier material (CM1), and
(ii) structuring the surface of the cured silicone layer by means of a laser to provide the micro- and/or nanostructured structured silicone layer (SiL).

Embodiment 7: process according to embodiment 6, wherein the carrier material (CM1) is selected from the group consisting of textiles, films of polyethylene terephthalate (PET), polyethylene naphthalate (PEN), polybutylene terephthalate, polyethylene, polypropylene, polyamide or polycarbonate, preferably PET or PEN films, glass fiber fabrics, composites made of glass fibers and suitable polymeric materials, papers, aluminum, steel, magnetic steel or other iron alloys.

Embodiment 8: process according to embodiment 6 or 7, wherein the cured silicone layer is obtained by (i) addition crosslinking of at least one compound having radicals with aliphatic carbon-carbon multiple bonds and at least one organopolysiloxane having Si-bonded hydrogen atoms and/or at least one organopolysiloxane having SiC-bonded radicals with aliphatic carbon-carbon multiple bonds and Si-bonded hydrogen atoms in the presence at least one hydrosilylation catalyst or (ii) condensation crosslinking of at least one polyorganosiloxane having condensable end groups and at least one organosilicone compound optionally having at least three hydrolyzable groups bonded to silicone per molecule in the presence at least one condensation catalyst.

Embodiment 9: process according to any of embodiments 6 to 8, wherein the micro- and/or nanostructured silicone layer (SiL) has a total thickness of 1 to 10 mm, preferably of 2 to 3 mm.

Embodiment 10: process according to any of embodiments 5 to 9, wherein the micro- and/or nanostructured composite (S1C1) is obtained by
(I) applying a radiation-curable coating composition (C1a) to at least a part of the surface of a substrate (S1) to provide a composite (S1C1a);
(II) at least partially embossing the coating composition (C1a) applied at least partly to the surface of the substrate (S1) by means of at least one embossing tool (E1) comprising at least one embossing mold (e1);
(III) at least partially curing the at least partially embossed coating composition (C1a) applied at least partially to a substrate (S1) which throughout the duration of the at least partial curing is in contact with the at least one embossing mold (e1) of the embossing tool (E1);
(IV) removing the composite (S1C1) from the embossing mold (e1) of the embossing tool (E1) to provide the at least partially embossed and at least partially cured composite (S1C1), or vice versa.

Embodiment 11: process according to embodiment 10, wherein the substrate (S1) is a selected from the group consisting of polymethyl (meth)acrylates, polybutyl (meth)acrylates, polyethylene terephthalates, polybutylene terephthalates, polyvinylidene fluorides, polyvinyl chlorides, polyesters, polycarbonates, polyvinyl acetate, polyamides, polyolefins, polyacrylonitrile, polyacetal, polyacrylonitrile-ethylene-propylene-diene-styrene copolymers (A-EPDM), polyetherimides, phenolic resins, urea resins, melamine resins, alkyd resins, epoxy resins, polyurethanes, polyetherketones, polyphenylene sulfides, polyethers, polyvinyl alcohols and mixtures thereof, preferably polyethylenterephthalat, poly(butylene terephthalate), polypropylene, polyethylene, polymethyl methacrylate (PMMA) or impact-modified PMMA.

Embodiment 12: process according to embodiment 10 or 11, wherein the thickness of the substrate (S1) is 2 μm to 5 mm, preferably 25 to 1000 μm, very preferably 50 to 300 μm.

Embodiment 13: process according to any of embodiments 10 to 12, wherein the coating composition (C1a) comprises

(a) at least one crosslinkable silicone polymer and/or silicone oligomer,
(b) at least one reactive diluent,
(c) at least one photoinitiator and
(d) optionally at least one additive,
wherein the coating composition (C1a) contains at least one silicone compound, preferably selected from crosslinkable silicone-containing polymers and/or oligomers.

Embodiment 14: process according to any of embodiments 10 to 13, wherein the coating composition (C1a) comprises—based on the total weight of (C1a):
(a) 9 to 35 weight % of exactly one silicone (meth)acrylate oligomer comprising on average 2 unsaturated groups,
(b) 55 to 83 weight % of hexane diol diacrylate and/or (meth)acrylates derived from 6-fold ethoxylated trimethylolpropane,
(c) 1 to 10 weight % of ethyl 2,4,6-trimethylbenzoylphenylphosphinate and/or 1-benzoylcyclohexan-1-ol and
(d) 0 or 0.5 to 3 weight % of an lubricity and/or antiblocking additive.

Embodiment 15: process according to any of embodiments 10 to 16, wherein the coating composition (C1a) comprises—based on the total weight of (C1a):
(a) 9 to 35 weight % of a mixture of exactly one urethane (meth)acrylate oligomer comprising on average 2 unsaturated groups and exactly one silicone (meth)acrylate comprising on average 0.5 to 3 unsaturated groups, wherein the mixture comprises a weight ratio of the urethane (meth)acrylate to the silicone (meth)acrylate of 10:1 to 8:1,
(b) 55 to 83 weight % of hexane diol diacrylate and/or (meth)acrylates derived from 6-fold ethoxylated trimethylolpropane,
(c) 1 to 10 weight % of ethyl 2,4,6-trimethylbenzoylphenylphosphinate and/or 1-benzoylcyclohexan-1-ol and
(d) 0 or 0.5 to 3 weight % of an lubricity and/or antiblocking additive.

Embodiment 16: process according to any of embodiments 10 to 15, wherein the embossing tool (E1) comprising at least one embossing mold (e1) is selected from metallic embossing tools, preferably nickel embossing tools, more particularly nickel embossing tools which contain small amounts of phosphorus.

Embodiment 17: process according to any of embodiments 10 to 16, wherein the at least partial embossing in step (II) takes place at the level of the roll nip which is formed by the two mutually opposing rolls, rotating counter-directionally or in the same direction, where the at least one embossing mold (e1) of the at least one embossing tool (E1) is facing the coating composition (C1a) of the composite (S1C1a).

Embodiment 18: process according to any of the preceding embodiments, wherein the micro-scale and/or nano-scale surface elements of the silicone containing layer, preferably the silicone layer (SiL) or the coating layer (C1) of composite (S1C1), have a structure width of 10 nm to 1,000 μm, preferably 25 nm to 400 μm, more preferably 50 nm to 250 μm, very preferably 100 nm to 200 μm or 1 μm to 200 μm.

Embodiment 19: process according to any of the preceding embodiments, wherein the micro-scale and/or nano-scale surface elements of the silicone containing layer, preferably the silicone layer (SiL) or the coating layer (C1) of composite (S1C1), have a structure height of 10 nm to 1,000 μm, preferably 25 nm to 400 μm, more preferably 50 nm to 300 μm, very preferably 100 nm to 200 μm or 1 μm to 200 μm.

Embodiment 20: process according to any of the preceding embodiments, wherein the micro-scale and/or nano-scale surface elements of the silicone containing layer, preferably the silicone layer (SiL) or the coating layer (C1) of composite (S1C1), are forming a regular or irregular pattern selected from serpentine patterns, sawtooth patterns, diamond-shape patterns, rhomboidal patterns, parallelogrammatical patterns, honeycomb patterns, circular patterns, punctiform patterns, star-shaped patterns, rope-shaped patterns, reticular patterns, polygonal patterns, such as triangular, tetragonal, rectangular, square, pentagonal, hexagonal, heptagonal and octagonal patterns, wire-shaped patterns, ellipsoidal patterns, oval and lattice-shape patterns, QR codes or combination of said patterns.

Embodiment 21: process according to any of the preceding embodiments, wherein the at least one binder (B) is selected from the group consisting of (i) poly(meth)acrylates, more particularly hydroxy-functional and/or carboxylate-functional and/or amine-functional poly(meth)acrylates, (ii) polyurethanes, more particularly hydroxy-functional and/or carboxylate-functional and/or amine-functional polyurethanes, (iii) polyesters, more particularly polyester polyols, (iv) polyethers, more particularly polyether polyols, (v) copolymers of the stated polymers, and (vi) mixtures thereof.

Embodiment 22: process according to any of the preceding embodiments, wherein the at least one binder (B) is present in a total amount of 15 to 55 wt % solids, preferably of 25 to 40 wt % solids, more particularly of 25 to 35 wt % solids, based in each case on the total weight of the composition (C2a).

Embodiment 23: process according to any of the preceding embodiments, wherein the at least one crosslinker (CL) is selected from the group consisting of amino resins, polyisocyanates, blocked polyisocyanates, polycarbodiimides, photoinitiators and mixtures thereof, preferably polyisocyanates.

Embodiment 24: process according to any of the preceding embodiments, wherein the at least one crosslinker (CL) is present in a total amount of 10 wt % to 40 wt %, preferably of 10 to 30 wt %, more particularly of 15 to 25 wt %, based in each case on the total weight of the composition (C2a).

Embodiment 25: process according to any of the preceding embodiments, wherein the composition (C2a) further comprises at least one organic or inorganic color pigment.

Embodiment 26: process according to any of the preceding embodiments, wherein the composition (C2a) is an aqueous or a solvent-based coating composition.

Embodiment 27: process according to any of the preceding embodiments, wherein the composition (C2a) has a solids content of 30 to 60 wt %, preferably of 35 to 55 wt %, more preferably of 40 to 50 wt %, more particularly of 42 to 48 wt %, measured according to ASTM D2369 (2015) (110° C., 60 min).

Embodiment 28: process according to any of the preceding embodiments, wherein the composition (C2a) is a one component or a two component coating composition, preferably a two component coating composition.

Embodiment 29: process according to embodiment 28, wherein the mixing of the two components of composition (C2a) is performed in an automatic mixing system, preferably comprising a mixing unit, more particularly a static mixer, and also at least two devices for the supply of components, more particularly gear pumps and/or pressure valves.

Embodiment 30: process according to any of the preceding embodiments, wherein the composition (C2a) is applied in step (2) manually or by means of an application robot.

Embodiment 31: process according to embodiment 30, wherein the application robot comprises at least one nozzle having a diameter of 0.05 to 1.5 mm, preferably of 0.08 to 1 mm, more particularly of 0.1 to 0.8 mm.

Embodiment 32: process according to any of the preceding embodiments, wherein the composition (C2a) is flashed off in process step (2) for a period of 0.2 to 20 minutes, preferably 1 to 20 minutes, more preferably of 2 to 10 minutes, very preferably of 4 to 6 minutes.

Embodiment 33: process according to any of the preceding embodiments, wherein the composition (C2a) is flashed off in process step (2) at a temperature of 20 to 190° C., more preferably 30 to 150° C., very preferably 40 to 140° C., more particularly 50 to 130° C. such as 50 to 70° C. or 120 to 130° C.

Embodiment 34: process according to any of the preceding embodiments, wherein the dry film thickness of the flashed composition (C2a) after process step (2) is 20 to 120 μm, more particularly 25 to 100 μm.

Embodiment 35: process according to any of the preceding embodiments, wherein the material (M1) inserted in process step (3) is an outsole, more particularly an outsole made of thermoplastic polyurethane.

Embodiment 36: process according to any of the preceding embodiments, wherein the mold (MO) is heated in process step (3) to a temperature of 20 to 100° C., more preferably 30 to 90° C., very preferably 40 to 80° C., more particularly 50 to 70° C.

Embodiment 37: process according to any of the preceding claims, wherein the composition (C3a) is a polymer foam material, more particularly selected from polyurethane foam materials, polystyrene foam materials, polyester foam materials, butadiene styrene blockcopolymer foam materials and aminoplast foam materials, very preferably from polyurethane foam materials.

Embodiment 38: process according to any of the preceding claims, wherein the composition (C3a) is applied automatically into the mold (MO) in process step (5).

Embodiment 39: process according to any of the preceding claims, wherein the application of composition (C3a) in process step (5) is performed by injection or by spraying.

Embodiment 40: process according to any of the preceding embodiments, wherein the composition (C3a) and optionally the composition (C2a) are at least partially cured in process step (6) at a temperature of 45 to 120° C., preferably 50 to 100° C., more particularly 52 to 95° C. for a period of 1 to 20 minutes, preferably after 3 to 15 minutes, more particularly after 4 to 10 minutes.

Embodiment 41: process according to any of the preceding embodiments, wherein the composition (C4a) is preferably different from the composition (C3a) and is selected from (i) polymer foam materials, more particularly selected from polyurethane foam materials, polystyrene foam materials, polyester foam materials, butadiene styrene blockcopolymer foam materials and aminoplast foam materials, very preferably from polyurethane foam materials, (ii) powder compositions and (iv) mixtures thereof.

Embodiment 42: process according to any of the preceding embodiments, wherein the composition (C4a) is at least partially cured in process step (7) at a temperature of 45 to 120° C., preferably 50 to 100° C., more particularly 52 to 95° C. for a period of 1 to 20 minutes, preferably after 3 to 15 minutes, more particularly after 4 to 10 minutes.

Embodiment 43: process according to any of the preceding embodiments, wherein the post-treatment in process step (9) comprises trimming and/or polishing and/or coating of the structured molded article obtained after process step (8).

Embodiment 44: process according to embodiment 43, wherein coating of the structured molded article is performed without intermediate sanding by applying at least one basecoat film and/or at least one clearcoat film and jointly or separately curing said basecoat and/or clearcoat film.

Embodiment 45: structured molded article, produced by the process as claimed in any of embodiments 1 to 44.

Embodiment 46: structured molded article according to embodiment 45, wherein the structured molded article is a shoe sole.

### EXAMPLES

The present invention will now be explained in greater detail through the use of working examples, but the present invention is in no way limited to these working examples. Moreover, the terms “parts”, “%” and “ratio” in the examples denote “parts by mass”, “mass %” and “mass ratio” respectively unless otherwise indicated. With regard to the stated formulation constituents and their quantities, the following should be borne in mind: any reference to a commercial product is to exactly that commercial product, irrespective of the particular principal name selected for the constituent.

### 1) Description of Methods:

### 1.1. Solids Content (Solids, Nonvolatile Fraction)

The nonvolatile fraction is determined according to ASTM D2369 (date: 2015). In this procedure, 2 g of sample are weighed out into an aluminum dish which has been dried beforehand, and the sample is dried in a drying cabinet at 110° C. for 60 minutes, cooled in a desiccator, and then reweighed. The residue, relative to the total amount of sample introduced, corresponds to the nonvolatile fraction.

### 1.2. Determination of Acid Number

The acid number is determined according to DIN EN ISO 2114 (date: June 2002), using “method A”. The acid number corresponds to the mass of potassium hydroxide in mg required to neutralize 1 g of sample under the conditions specified in DIN EN ISO 2114. The acid number reported corresponds here to the total acid number as specified in the DIN standard, and is based on the solids content.

### 1.3. Determination of OH Number

The OH number is determined according to DIN 53240-2. The OH groups are reacted by acetylation with an excess of acetic anhydride. The excess acetic anhydride is subsequently split by addition of water to form acetic acid, and the entire acetic acid is back-titrated with ethanolic KOH. The OH number indicates the quantity of KOH in mg that is equivalent to the amount of acetic acid bound in the acetylation of 1 g of sample. The OH number is based on the solids content of the sample.

### 1.4. Determination of Number-Average and Weight-Average Molecular Weight

The number-average molecular weight (Mn) is determined by gel permeation chromatography (GPC) according to DIN 55672-1 (March 2016). Besides the number-average molecular weight, this method can also be used to determine the weight-average molecular weight (Mw) and also the polydispersity d (the ratio of weight-average molecular weight (Mw) to number-average molecular weight (Mn)). Tetrahydrofuran is used as the eluent. The determination is made against polystyrene standards. The column material consists of styrene-divinylbenzene copolymers.

### 1.5. Determining of Demoldability

The success of demoldability of the structured article from the three-dimensional mold is determined by removing the mold parts and visually assessing the obtained structured article. If the structured article could be fully demolded and no damage is detected visually, the demoldability is “OK”. If the structured article could not be demolded or the structured article was visually destroyed during demolding, the demoldability is rated “not OK”.

1.6. Determination of Residues on Structured Surface of the Article after Demolding:

Residues remaining on the structured surface after demolding were determined by scanning electron microscopy. Images of the structured surface of the demolded article were recorded with magnifications of up to 1000× after demolding. If the structured surface of the article showed no visual additional residues using a 1000× magnification, the rating is “No”. If the structured surface showed visual additional residues using a 1000× magnification, the rating is “Yes”.

### 2) Production of Structured Silicone Layer (SiL) and Composite (S1C1)

### 2.1 Production of Structured Silicone Layer (SiL)

A structured silicone layer (SiL) was prepared according to Example 5 of EP 2 057 000 B1 with the following deviation:

Instead of the negative pattern disclosed in EP 2 057 000 B1, a negative honeycomb pattern was engraved by means of a laser.

### 2.2 Production of Composite (S1C1)

Composites (S1C1) containing a plurality of microscale surface elements were prepared using a roll-to-roll or roll-to-plate embossing tool comprising microstructure A and coating composition E1a according to pages 58 to 59 of WO 2019/185833 A1.

### 3) Used Compositions C2a

The following compositions C2a were used in the molding process described in point 4) below (all ingredients are given in % by weight):

| | | C2a-1 | C2a-2 |
|---|---|---|---|
| 1 | Parocryl 4085 ¹⁾ | 8.24 | 8.24 |
| 2 | Desmophen 670 BA ²⁾ | 56.24 | 56.24 |
| 3 | 1-Methoxy-2-propyl acetate | 4.16 | 4.16 |
| 4 | Butyl acetate | 4.64 | 4.64 |
| 5 | Additive MI-8010 ³⁾ | 3.76 | — |
| 6 | Silmer OHT Di-10 ⁴⁾ | 2.24 | — |
| 7 | Tinuvin 1130 ⁵⁾ | 0.72 | 0.72 |
| 8 | Base color red ⁶⁾ | 9.76 | 9.76 |
| 9 | Base color pearl white ⁷⁾ | 7.80 | 7.80 |
| 10 | Base color white ⁸⁾ | 2.44 | 2.44 |
| 11 | 1-Methoxy-2-propyl acetate | 29.92 | 29.92 |
| 12 | K-Kat XK-651 ⁹⁾ | 1.12 | 1.12 |
| 13 | Desmodur N 3800 ¹⁰⁾ | 25.52 | 25.52 |

¹⁾ hydroxyl-functional poly(meth)acrylate having a hydroxyl number of 82.5 mg KOH/g, an acid number of 10 mg KOH/g, Mₙ about 6800 g/mol, M_{w} about 17 000 g/mol (BASFSE),
²⁾ polyester polyol having a hydroxyl number of 115 mg KOH/g and a hydroxyl functionality of about 3.5 (Covestro),
³⁾ mixture of compounds of the formula R¹-(C=O)ᵣ-O-(AO)ₛ-R², composed of (a) R¹ = mixture of saturated and unsaturated hydrocarbon radicals having 12 to 22 carbon atoms, r = 0, AO = mixture of primarily ethylene oxide units and a few propylene oxide units, and R² = H (Mₙ ≈ 650 g/mol); and (b) R¹ = unsaturated hydrocarbon radical having 21 carbon atoms, s = 0, and R² = H (Münch Chemie International GmbH),
⁴⁾ hydroxy-modified polysiloxane of the formula (III) with the above-recited radicals (Siltec GmbH & Co. KG),
⁵⁾ UV absorber (BASF Corporation),
⁶⁾ Glasurit paste 55-A 353 magenta rot
⁷⁾ Glasurit paste 55-M 011 perlweiss fein
⁸⁾ Glasurit paste 55-M 025 weiss
⁹⁾ bismuth neodecanoate (King Industries),
¹⁰⁾ hexamethylene diisocyanate trimer of isocyanurate type with an NCO content of 11.0 wt % (Covestro),

Compositions C2a-1 and C2a-2 were prepared as follows: ingredients 11 to 13 were mixed and added to a previously mixed ingredients 1 to 10.

Additionally, composition C2a-3 is prepared as described for composition kE1 on pages 38 to 39 of WO 2018/073034 A1.

### 4) Production of Structured and Optionally Coated Articles by a Molding Process

Structured and optionally coated articles in form of footwear soles are produced by the following molding process.

### 4.1 Preparation of Structured Molds (Step (1) of Inventive Process)

A mold in plate form comprising 2 movable mold parts was used in each case. The respective silicone layer (SiL) or composite (S1C1) was inserted on one mold part such that the complete surface of the mold part was covered. The following molds were prepared:

| # Mold | inlay |
|---|---|
| MO1 | Silicone layer (SiL) |
| MO2 | Composite S1C1 comprising |
| | microstructure A |

### 4.2 Application of Composition C2a (Step (2) of the Inventive Process)

Compositions C2a-1 and C2a-2 are each applied pneumatically (SATA Jet 4000 B HVLP with nozzle 1.0) to all surfaces of the mold parts facing the mold cavity of mold MO2. The mold surfaces coming in contact with these compositions had a temperature of 65° C. Afterwards, the compositions C2a-1 to C2a-3 are flashed off at 65° C. for 5 minutes. A dry film thickness after flash off of about 50 to 60 80 μm (determined by a cross section analyzed by light microscopy)) was obtained.

Apart from compositions C2a-1 and C2a-2, an external release agent Super Release S (commercially available from MARBO ITALIA spa.) not comprising a binder was also applied as a comparison to all surfaces of the mold parts facing the mold cavity of mold MO2.

In case of mold MO1, no composition (C2a) was applied before injecting the foam material as described below.

### 4.3 Injection of Foam Material (C3a) (Steps (4) and (5))

The mold parts are closed and a polyurethane foam material is injected into the closed mold. The polyurethane foam system is obtained by mixing component A (Elastopan S 7859/102—containing polyether polyols, stabilizers and amine catalyst) and component B (Iso 137/53—4,4′-diphenylmethane diisocyanate) in a ratio of 100:49 (commercially available foam system Elastopan S 7859/102). The foam density is around 330 g/cm³.

### 4.4 Curing of Compositions (C2a-1) to (C2a-3) as Well as Foam Material (C3a) (Steps (4) to (6))

The curing of the respective composition (C2a-1) to (C2a-3) and also the formation of the polyurethane foam from the foam material (C3a) take place over a period of 4 minutes in the closed mold at 65° C.

### 4.5 Opening and Removing the Structured and Optionally Coated Article (Step (8))

After the cure time has elapsed, the mold is opened and the structured and optionally coated article is removed from the mold.

### 5) Results

The demoldability and the presence of residues on the surface were determined as described in point 1). The results are summarized in the following Table:

| | Composition | | Residues |
|---|---|---|---|
| Mold | C2a | Demoldabilty | on surface |
| MO1 | None | OK | No |
| MO2 | C2a-1 | OK | No |
| MO2 | C2a-2 | OK | No |
| MO2 | External agent | Not OK | Yes |

¹⁾ not determined
All structures were transferred to the structured objects tin a sufficient quality.

As can be seen from this Table, structured articles being prepared by using a composition (C2a) comprising at least one binder (inventive process) show an improved demoldability and do not have any unwanted residues on the structured surface. In contrast, the use of an external release agent not comprising a binder (non-inventive process) does only result in partial demolding of the article from the mold. Additionally, the surface that could be demolded showed residues of the external release agent which have to be removed prior to post-treatment.

The coating layer provided on the structured surface does not interfere with the success of replication, meaning that the coating allows to improve the demoldability without negatively influence the transfer of the structure from the mold part to the foam material. Thus, the inventive process allows to simultaneously coat and structure three-dimensional foam articles. The coating layer shows a high adhesion to the structured surface. Moreover, the coating layer is highly flexible and does not show any delamination during bending or mechanical stress. Since also pigmented structured foam articles can be produced with the inventive process, said process renders time- and cost-intensive post-coating processes superfluous.

Additionally, a good demolding of the structured article is also obtained in case of the use of a structured silicone layer (mold MO1) without the use of a composition (C2). Thus, the inventive process is highly versatile and allows to provide three dimensional articles having the desired structured surface which can optionally be coated with a flexible and highly durable coating layer.

1. A process for preparing a molded article comprising at least one structured surface, said process comprising the following steps in the stated order:
(1) providing a closable, three dimensional mold (MO) having at least two mold parts which are movable relative to each other and which form a mold cavity, wherein at least one micro- and/or nanostructured silicone containing layer comprising a plurality of micro-scale and/or nano-scale surface elements is attached to at least a part of the inner surface (SU) facing the mold cavity of at least one of the mold parts;
(2) optionally applying a composition (C2a) comprising at least one binder (B) and optionally at least one crosslinker (CL) on at least a part of at least one inner surface (SU) facing the mold cavity of the closable, three dimensional mold (MO) and flashing off said applied composition (C2a);
(3) optionally inserting at least one material (M1) into the mold (MO), and heating the mold (MO);
(4) optionally closing the mold (MO);
(5) applying a composition (C3a) into the closed mold (MO) or applying a composition (C3a) into the open mold (MO) and closing said mold (MO);
(6) at least partially curing the composition (C3a) and optionally the composition (C2a);
(7) optionally applying at least one further composition (C4a) and at least partially curing said composition (C4a);
(8) opening the mold (MO) and removing the molded article comprising at least one structured and optionally coated surface; and
(9) optionally post-treating the article obtained after step (8).

2. The process according to claim 1, wherein the process is a manual process or an automatic process.

3. The process according to claim 1, wherein the mold parts are selected from the group consisting of metallic mold parts, steel, nickel or copper mold parts, polymeric mold parts, and polyamide mold parts.

4. The process according to claim 1, wherein the unstructured side of the silicone containing layer is attached on at least one inner surface (SU) of the at least one mold part, said at least one mold part facing the mold cavity, and wherein said attached silicone containing layer is optionally fixed by means of pressure differences, vacuum, an adhesive layer, clamping or magnetic forces on said inner surface (SU1).

5. The process according to claim 1, wherein the silicone containing layer is selected from the group consisting of
(i) at least one micro- and/or nanostructured silicone layer (SiL) containing a plurality of micro-scale and/or nano-scale surface elements and
(ii) at least one composite (S1C1) comprising a substrate (S1) and at least one micro- and/or nanostructured coating layer (C1) containing at least one silicone compound and a plurality of micro-scale and/or nano-scale surface elements.

6. The process according to claim 5, wherein the micro- and/or nanostructured silicone layer (SiL) is obtained by
(i) providing a cured silicone layer, optionally on a carrier material (CM1), and
(ii) structuring the surface of the cured silicone layer by means of a laser to provide the micro- and/or nanostructured structured silicone layer (SiL).

7. The process according to claim 5, wherein the micro- and/or nanostructured composite (S1C1) is obtained by
(I) applying a radiation-curable coating composition (C1a) to at least a part of the surface of a substrate (S1) to provide a composite (S1C1a);
(II) at least partially embossing the coating composition (C1a) applied at least partly to the surface of the substrate (S1) by means of at least one embossing tool (E1) comprising at least one embossing mold (e1);
(III) at least partially curing the at least partially embossed coating composition (C1a) applied at least partially to a substrate (S1) which throughout the duration of the at least partial curing is in contact with the at least one embossing mold (e1) of the embossing tool (E1); and
(IV) removing the composite (S1C1) from the embossing mold (e1) of the embossing tool (E1) to provide the at least partially embossed and at least partially cured composite (S1C1), or vice versa.

8. The process according to claim 1, wherein the micro-scale and/or nano-scale surface elements of the silicone layer (SiL) or the coating layer (C1) of composite (S1C1) each have a structure width of 10 nm to 1,000 μm.

9. The process according to claim 1, wherein the micro-scale and/or nano-scale surface elements of the silicone layer (SiL) or the coating layer (C1) of composite (S1C1) each have a structure height of 10 nm to 1,000 μm.

10. The process according to claim 1, wherein the at least one binder (B) is selected from the group consisting of (i) poly(meth)acrylates, (ii) polyurethanes, (iii) polyesters, (iv) polyethers, (v) copolymers thereof, and (vi) mixtures thereof.

11. The process according to claim 1, wherein the at least one binder (B) is present in a total amount of 15 to 55 wt % solids, based on the total weight of the composition (C2a).

12. The process according to claim 1, wherein the composition (C3a) is a polymer foam material.

13. The process according to claim 1, wherein the composition (C3a) and optionally the composition (C2a) are cured in process step (6) at a temperature of 45 to 120° C. for a period of 1 to 20 minutes.

14. The process according to claim 1, wherein the post-treatment in process step (9) comprises trimming and/or polishing and/or coating the structured molded article obtained after process step (8).

15. A structured molded article, produced by the process as claimed in claim 1.

16. The process according to claim 1, wherein the at least one material (M1) is not in contact with the inner surface (SU) of the mold parts comprising the silicone containing layer.

17. The process according to claim 1, wherein the micro-scale and/or nano-scale surface elements of the silicone layer (SiL) or the coating layer (C1) of composite (S1C1) each have a structure width of 25 nm to 400 μm.

18. The process according to claim 1, wherein the micro-scale and/or nano-scale surface elements of the silicone layer (SiL) or the coating layer (C1) of composite (S1C1) each have a structure height of 25 nm to 400 μm.

19. The process according to claim 1, wherein the at least one binder (B) is selected from the group consisting of (i) hydroxy-functional and/or carboxylate-functional and/or amine-functional poly(meth)acrylates, (ii) hydroxy-functional and/or carboxylate-functional and/or amine-functional polyurethanes, (iii) polyester polyols, (iv) polyether polyols, (v) copolymers thereof, and (vi) mixtures thereof.

20. The process according to claim 1, wherein the at least one binder (B) is present in a total amount of 25 to 40 wt % solids.
